(19) United States
(12) Patent Application Publication
(10) Pub. No.: US 2026/0098872 A1
(43) Pub. Date: Apr. 9, 2026

(54) HYBRID MODULAR PATHOLOGY ARCHIVE SCANNING

(71) Applicant: QTC MANAGEMENT, INC., San Dimas, CA (US)

(72) Inventors: Todd Rothrock Minnigh, Brookfield, WI (US); Shabbir Akbar Bharmal, Ellicott City, MD (US); Larry John Schaefer, San Antonio, TX (US); Mario Hendricks, San Dimas, CA (US)

(21) Appl. No.: 19/354,470

(22) Filed: Oct. 9, 2025

Related U.S. Application Data
(60) Provisional application No. 63/705,405, filed on Oct. 9, 2024.

(51) Int. Cl. G01N 35/00; G06T 7/00

(52) U.S. Cl. CPC G01N 35/0099; G01N 35/0092; G06T 7/0012; G01N 2035/00138; G06T 2207/10056; G06T 2207/30004

(57) ABSTRACT

Methods and systems are provided for optimizing the digital scanning of pathology slides in a transportable lab. A computing device-implemented method is described for receiving a plurality of pathology slides in the transportable lab, sorting the plurality of pathology slides based upon pathology slide condition to determine which of a plurality of scanners to utilize, and scanning at least one of the plurality of pathology slides utilizing Whole Slide Imaging or Whole Slide Imaging with Robotic Z-Stacking to generate a digital pathology slide. Transportable systems for scanning pathology slides, as described herein, include a triage stage for analyzing each of the pathology slides for digital scanning, a plurality of first slide imaging apparatuses for Whole Slide Imaging, and a plurality of second slide imaging apparatuses for Whole Slide Imaging with Robotic Z-Stacking.

### RELATED APPLICATION

This application claims priority to, and the benefit of, United States Provisional Patent Application No. 63/705,405, filed October 9, 2024, the contents of which are incorporated herein by reference in their entirety.

### BACKGROUND

Pathologists study blood, urine, tissue and other materials removed from a patient to diagnose illness or disease. Large pathology slide archives contain critical historical data of pathologies from cancers to pandemics and other diseases. Many of these archives are over one million pathology slides, with the largest exceeding over fifty million pathology slides. Given the size of these pathology slide archives, they may be stored in decentralized locations.

### SUMMARY

According to an embodiment, a computing device-implemented method is provided. The computing device-implemented method to optimize digital scanning of pathology slides in a transportable lab includes receiving a plurality of pathology slides in the transportable lab, sorting the plurality of pathology slides based upon pathology slide condition to determine which of a plurality of scanners to utilize, and scanning at least one of the plurality of pathology slides utilizing Whole Slide Imaging or Whole Slide Imaging with Robotic Z-Stacking to generate a digital pathology slide.

According to an embodiment, a transportable system is provided. The transportable system for scanning pathology slides includes a triage stage for analyzing each of the pathology slides for digital scanning, a plurality of first slide imaging apparatuses for Whole Slide Imaging, and a plurality of second slide imaging apparatuses for Whole Slide Imaging with Robotic Z-Stacking.

### BRIEF DESCRIPTION OF DRAWINGS

The skilled artisan will understand that the drawings are primarily for illustrative purposes and are not intended to limit the scope of the subject matter described herein. The drawings are not necessarily to scale; in some instances, various aspects of the subject matter disclosed herein may be shown exaggerated or enlarged in the drawings to facilitate an understanding of different features. In the drawings, like reference characters generally refer to like features (e.g., functionally similar or structurally similar elements).

The foregoing and other features and advantages provided by the present disclosure will be more fully understood from the following description of exemplary embodiments when read together with the accompanying drawings, in which:

FIG. 1 is a side view of a transportable lab in a container mounted on a truck frame according to an example embodiment.

FIG. 2 is a top view of a transportable lab according to an example embodiment.

FIG. 3 depicts an exemplary environment suitable for practicing one or more embodiments of the present disclosure.

FIG. 4 depicts an example flow diagram of a triage method taught herein for triaging pathology slides prior to scanning.

FIG. 5 depicts an example flow diagram of a method taught herein for utilizing WSI.

FIG. 6 depicts an example flow diagram of a method taught herein for utilizing WSI with RZS.

FIG. 7 depicts an example flow diagram of a scanning process including a WSI scanning device and a WSI with RZS scanning device.

FIG. 8 depicts an example process of imaging a pathology slide from different angles.

FIG. 9 depicts example pathology slides with flaws.

FIG. 10 depicts an example robotic arm placing pathology slides in different trays.

FIG. 11 depicts an example conveyor belt system for scanning pathology slides in a transportable lab.

FIG. 12 depicts an example hardware architecture for hybrid modular pathology archive scanning.

FIG. 13 depicts an example side view trapezoidal prism design of an optical setup for imaging pathology slides.

FIG. 14 depicts an example box hood top view of a camera top view.

FIG. 15 depicts an example slide tray close up.

FIG. 16 depicts an example illustration of alternate bezel and slide fit.

FIGS. 17A and 17B depict an example model training report for efficientnet.

FIGS. 18A and 18B depict an example model training report for RESNET50.

### DETAILED DESCRIPTION

Large pathology slide archives contain critical historical data of pathologies from cancers to pandemics and other diseases. Digital scanning of these pathology slides provides a means to mitigate data loss through pathology slide or tissue degradation over time. It also enables the sharing of information for research and education, and the training of artificial intelligence models for detection and classification of these diseases. Many of these archives are over one million pathology slides, with the largest exceeding fifty million pathology slides.

As taught herein, hybrid modular pathology archive scanning provides a means to digitize millions of pathology slides in a small space for research, education, and the development of artificial intelligence by combining different scanning methods in a transportable environment, for example, a modular transportable lab. In particular, hybrid modular pathology archive scanning can substantially reduce loading time for pathology slides and time spent on reprocessing failed pathology slide scans. In one or more embodiments, pathology slide scanners in the transportable lab include WSI performing a WSI methodology and/or WSI with RZS performing a WSI with RZS methodology. In one or more embodiments, the scanning of pathology slides converts an analog slide to a digital image (i.e., a digital pathology slide). These modular transportable labs can be grouped in clusters to rapidly process large archives of analog pathology slides. Modularity is important since once an archive is scanned, the need for the transportable lab no longer exists and the transportable lab can be relocated to a different pathology slide archive. Hybrid modular pathology archive scanning includes container modularity, hybrid scanning, and automated presorting methods. In one or more embodiments, a hybrid modular pathology archive scanning performs methods of pathology slide scanning including WSI and WSI with RZS. In WSI, a digital scanning microscope is focused on tissue at one level and produces a digital pathology slide. In particular, the digital scanning microscope is adjusted so that the lens focuses on a pathology slide at a single optical plane or focal depth for the whole scan rather than capturing structures above or below that plane. WSI helps ensure that a resulting image is clear at a particular level of focus and the scanner then systematically moves across the entire pathology slide to capture adjacent regions at the same depth that are computationally integrated together to produce a high resolution digital scan of the pathology slide. A user can then zoom in and out of resulting digital pathology slides and examine tissue samples at various magnification levels.

In WSI with RZS, a robotic arm feeds multiple scanners that individually scan pathology slides at multiple focal planes. Images are captured at different focal points and then combined to create a single image with an extended depth of field. In one or more embodiments, artificial intelligence distinguishes tissue from noise and removes any noise (e.g., dirt, bubbles, etc.) to provide an improved image of an otherwise difficult to scan pathology slide. WSI with RZS is particularly useful for working with three-dimensional specimens where an entire object cannot be in focus at once due to its thickness. In particular, such thickness can introduce technical challenges when different structures within a three-dimensional specimen lie at different focal depths and a single optical plane is insufficient. To address this issue, WSI with RZS captures multiple images at incremental focal planes and computationally integrates such images so that the composite digital pathology slide represents the full depth of the entire object in clear focus. WSI with RZS is tolerant of inconsistent pathology slide shapes (e.g., off sizes or overhanging coverslips) and can compensate for physical irregularities to ensure that diagnostically important structures are visible and in focus. In some embodiments, if WSI with RZS is unable to process a pathology slide, WSI with RZS rejects the pathology slide from further processing. In one or more embodiments, WSI with RZS requires 5-6x the space of WSI to produce the same result, but slide preparation effort, time, and space are often reduced. In one or more embodiments, a combination of scanners utilizing WSI and scanners utilizing WSI with RZS can optimize the overall capacity of a transportable lab for processing pathology slides because not all pathology slides need the fault tolerance afforded by scanners utilizing WSI with RZS. In one or more embodiments, the optimal number of scanners utilizing WSI versus WSI with RZS is proportional to the percentage of pathology slides that are designated to be processed by WSI versus WSI with RZS.

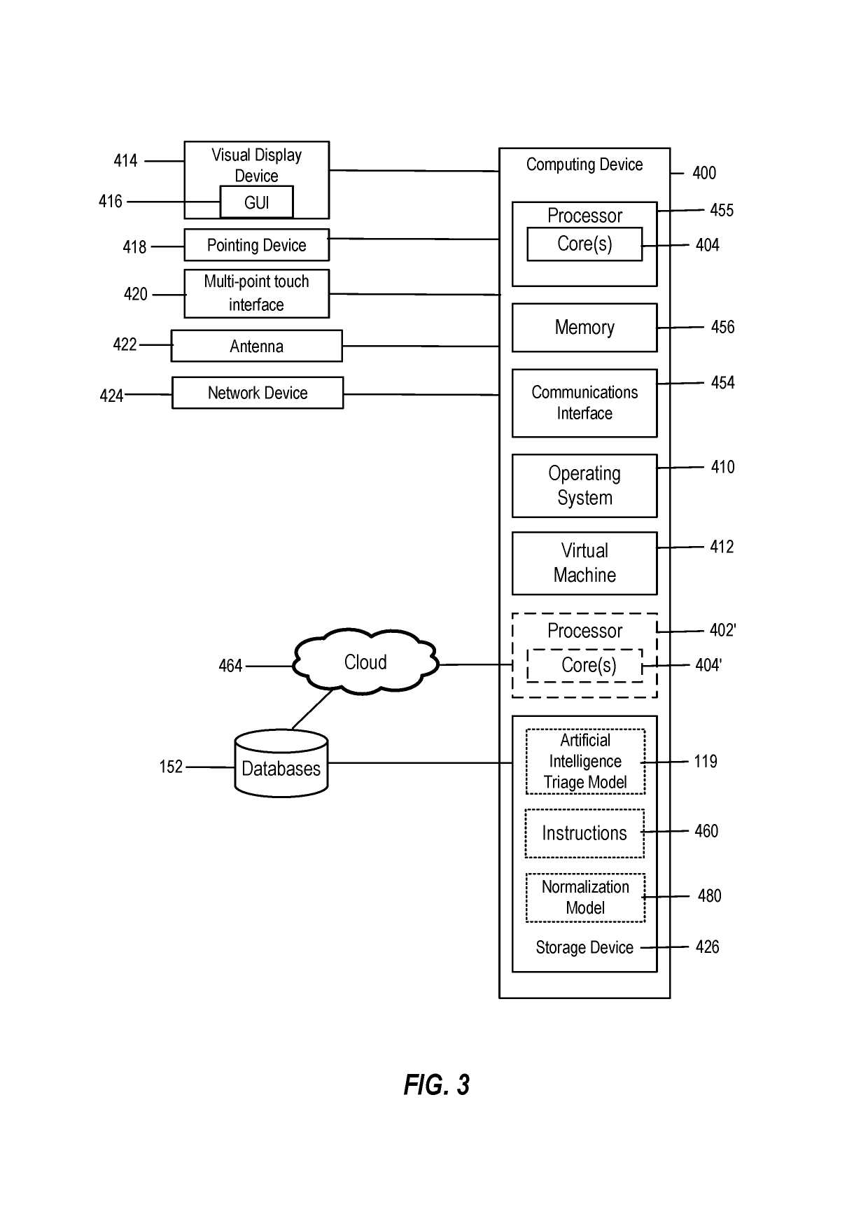

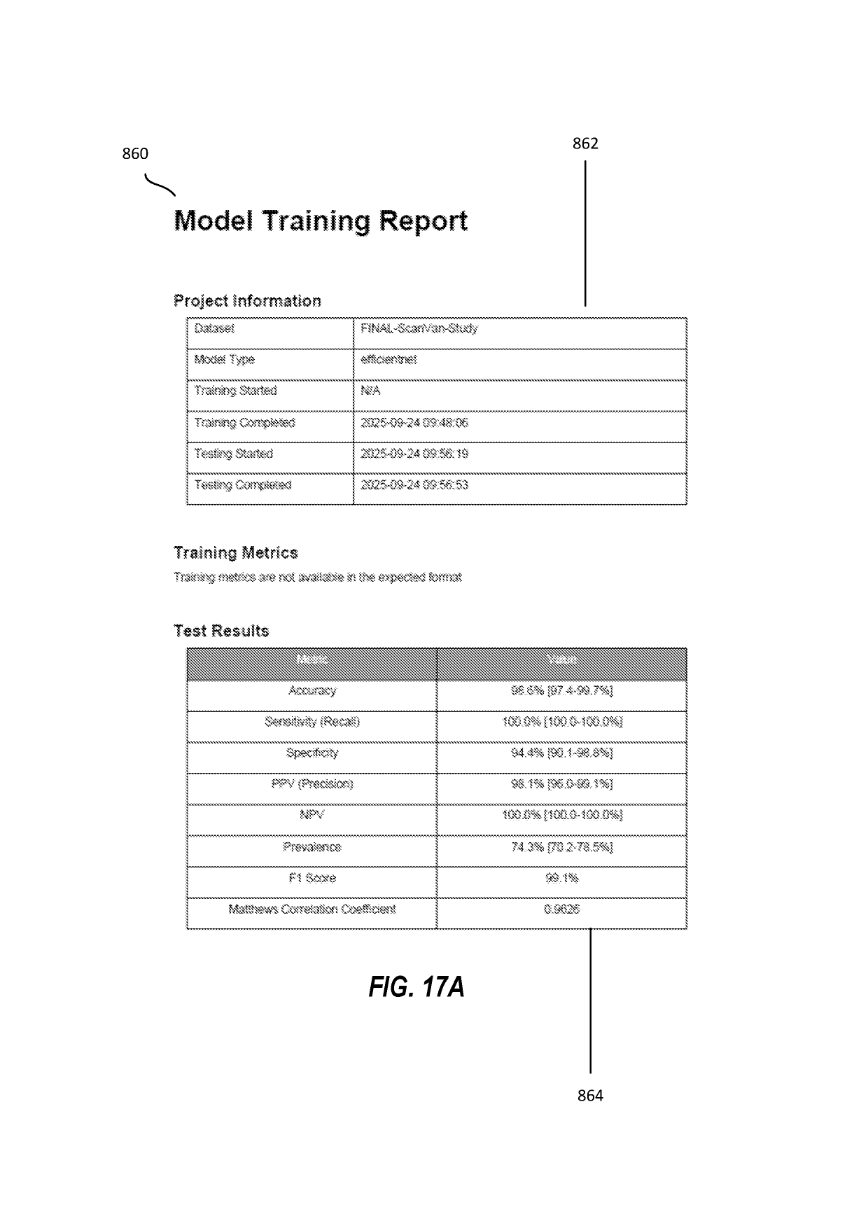

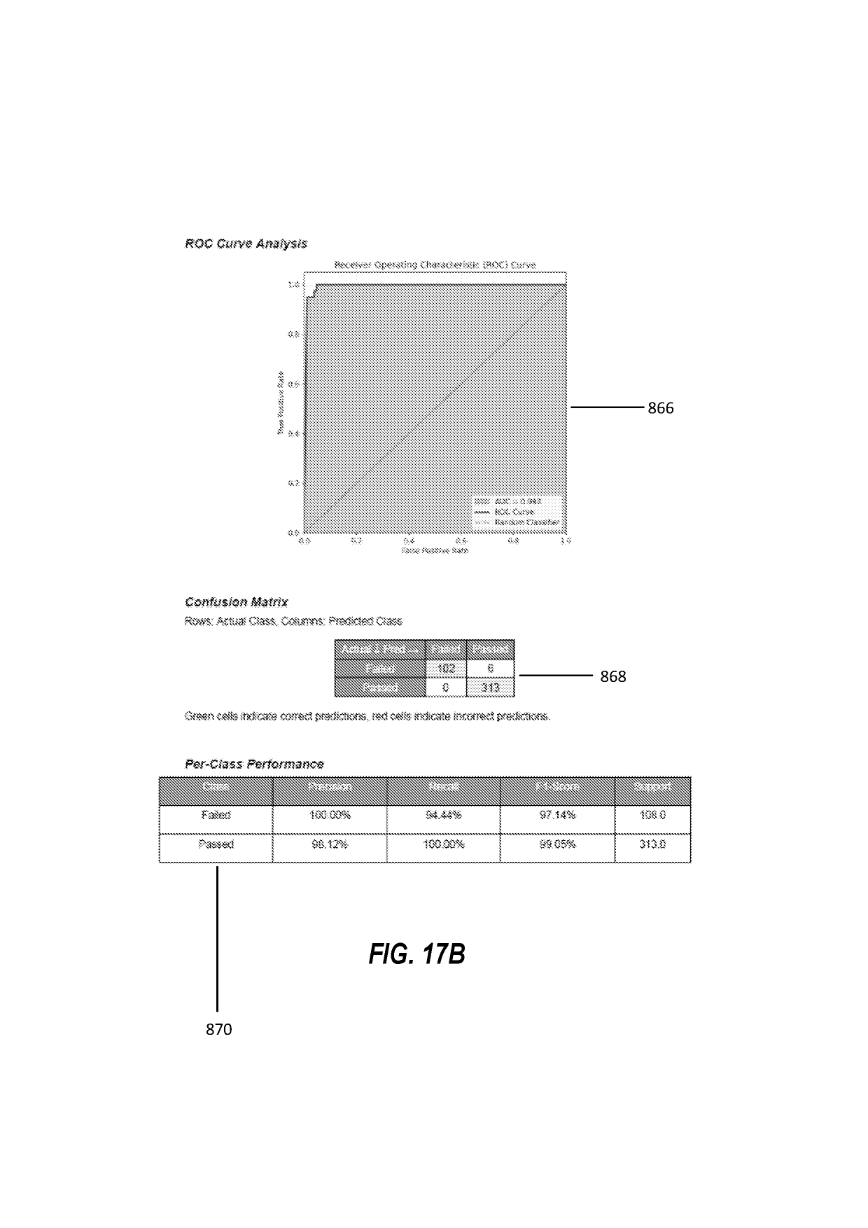

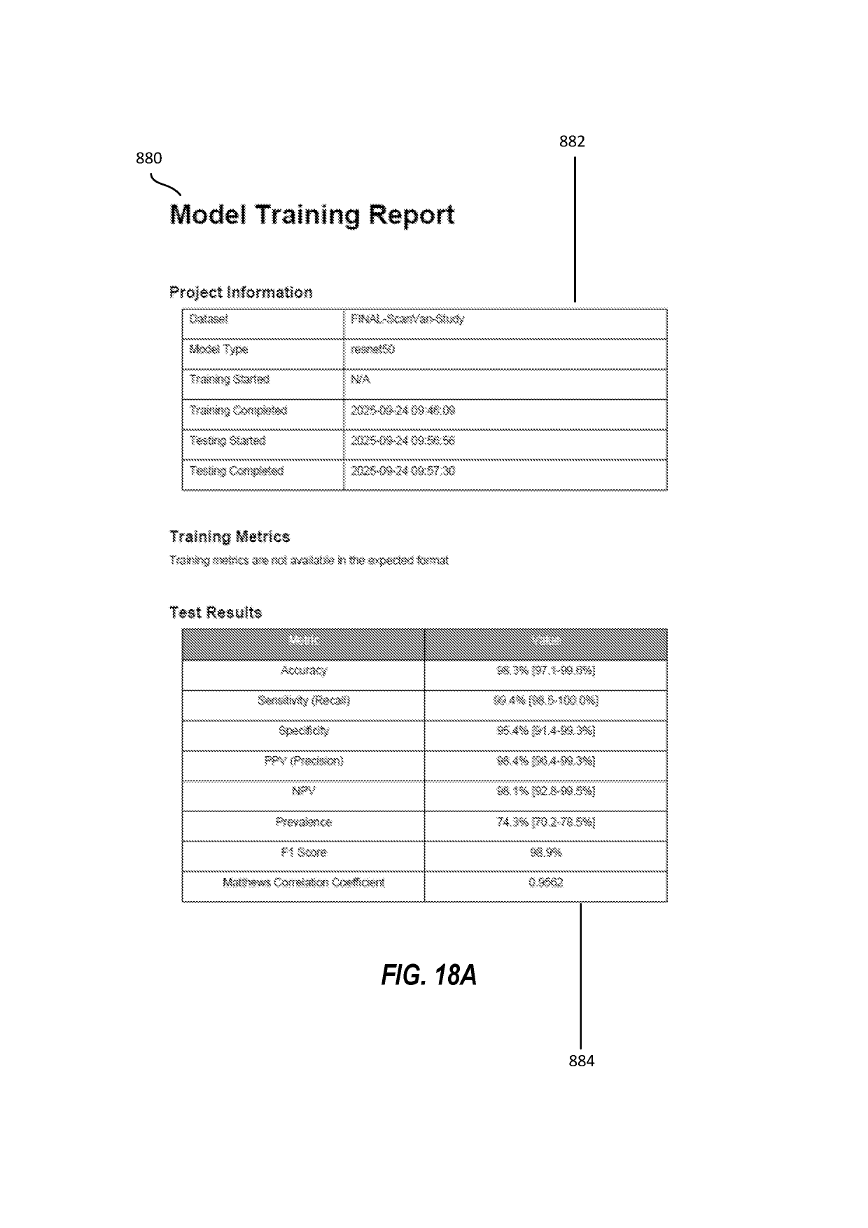

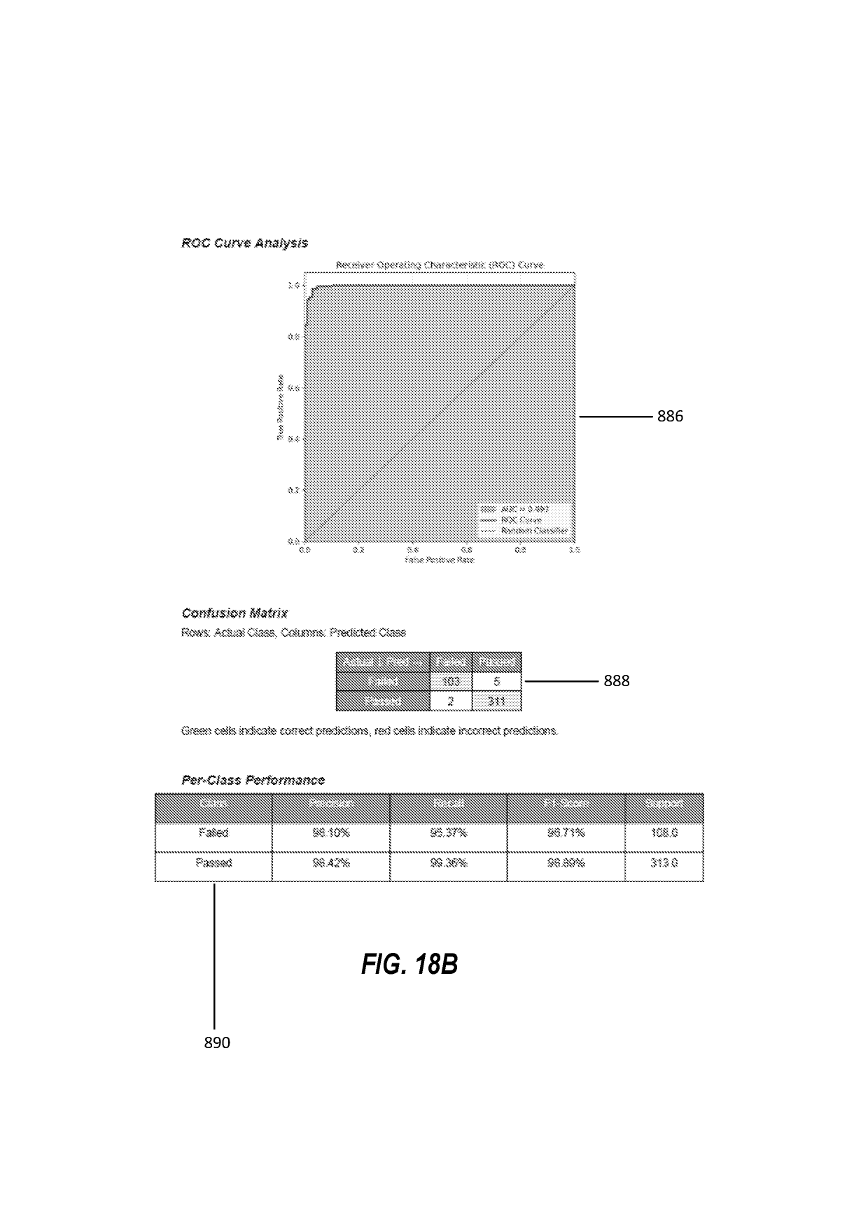

Hybrid optimization as taught herein preselects which pathology slides to clean and which pathology slides not to clean. In one or more embodiments, a computer does this through a rapid pre-scanning technique using artificial intelligence triage for example by using artificial intelligence triage model 119 as depicted in FIG. 3. Automation at this stage may also include specific pathology slide preparation guidance such as how to clean any pathology slides robotically. Furthermore, automation at this stage may include programmatically sorting pathology slides based upon pathology slide condition to determine which scanner to utilize. In some embodiments, the automation for sorting pathology slides based upon pathology slide condition is carried out based on a trained artificial intelligence model (e.g., the artificial intelligence triage model 119). In some embodiments, the artificial intelligence triage model 119 is based upon a hybrid model that incorporates aspects of a plurality of convolutional neural networks (e.g., efficientnet, RESNET50, mobilenet, etc.). In some embodiments, training of the artificial intelligence triage model 119 involves testing the performance of one or more convolutional neural networks and generating a model training report (see FIGS. 17A-17B for a model training report for efficientnet and FIGS. 18A-18B for a model training report for RESNET50). In some embodiments, the artificial intelligence triage model 119 can be trained on a corpus of pathology slide images that indicates which scan protocol is best to use based on the condition of the pathology slide. The optimization of this workflow enables maximum efficiency. This approach may exist within one transportable lab, or the same concept could be applied to a cluster of such labs. In some embodiments, one transportable lab can sort pathology slides, one transportable lab can scan pathology slides using WSI with RZS, one transportable lab can clean pathology slides, and one transportable lab can scan pathology slides using WSI. The notion of hybrid modular scanning is maintained in this and other embodiments.

In some embodiments, the artificial intelligence triage model 119 can distinguish tissue from noise by applying image processing techniques to separate biologically relevant structures from irrelevant noise such as dust, staining irregularities, etc. that do not contribute to image accuracy. In some embodiments, the artificial intelligence triage model 119 is trained to learn which features or patterns correspond to failed pathology slides by analyzing examples of previously failed pathology slides. In some embodiments, the artificial intelligence triage model 119 outputs a single binary decision (e.g., pass or fail) to evaluate a pathology slide’s image quality without distinguishing between different types of errors or failure causes. In some embodiments, the artificial intelligence triage model 119 identifies and distinguishes between different failure modes (e.g., dirt, bubbles, etc.) so that each type of detected defect is labeled separately rather than collapsed into a binary decision (e.g., pass or fail).

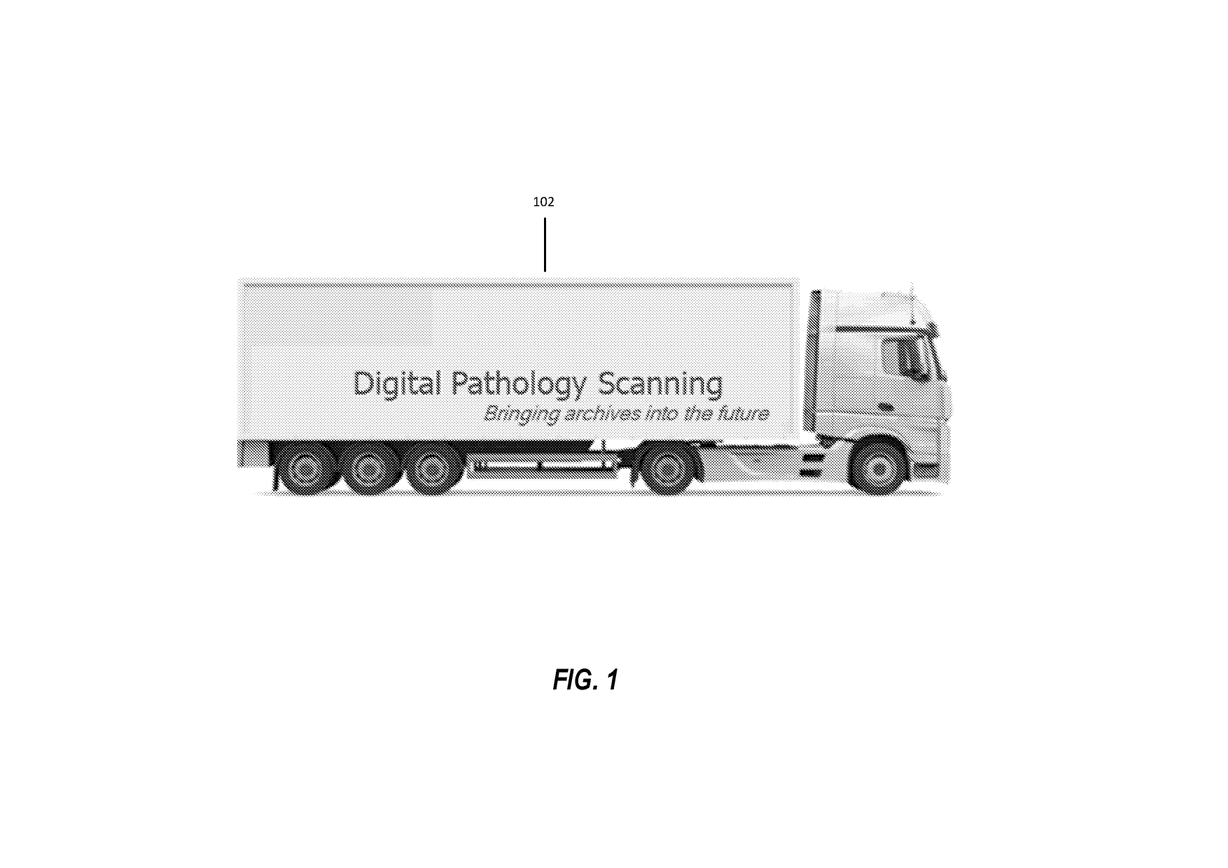

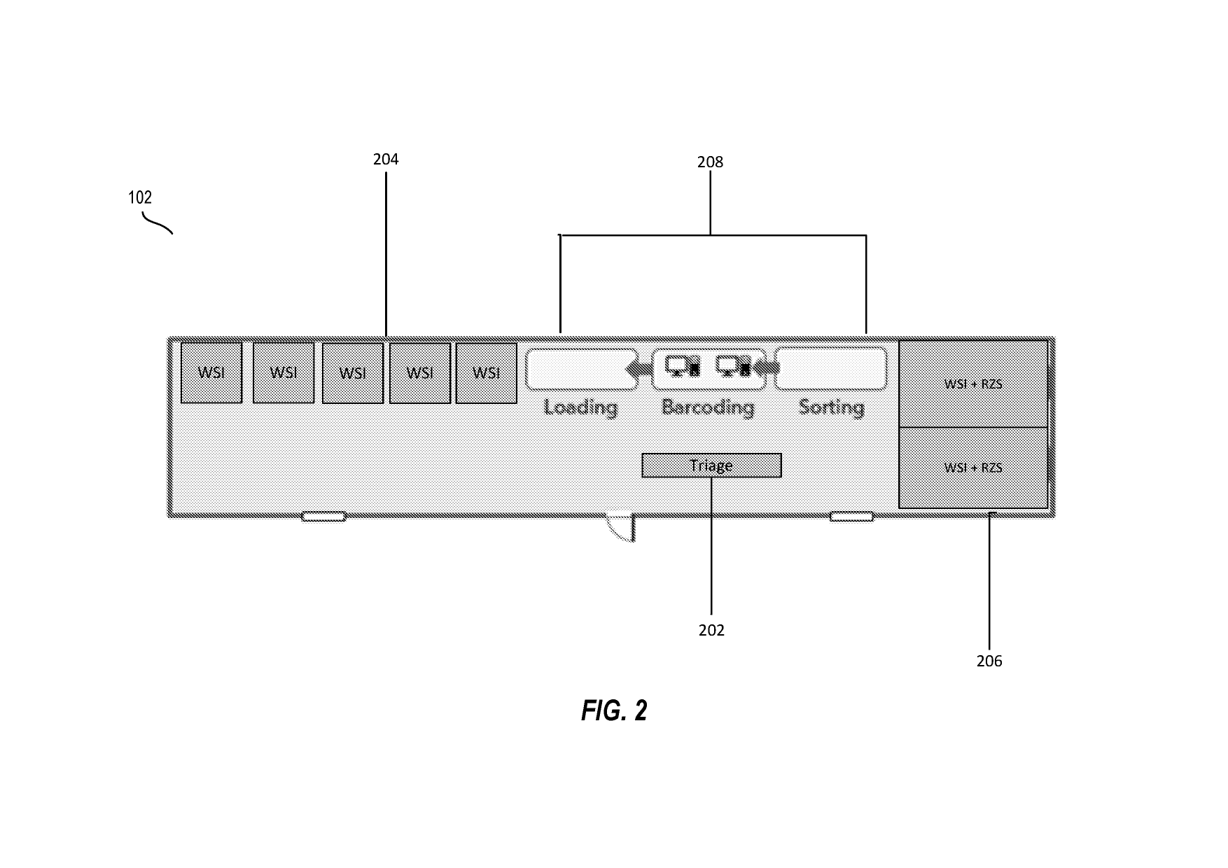

FIG. 1 is a side view of an example transportable lab as taught herein. In one or more embodiments, the transportable lab 102 is able to process pathology samples to create digital images from analog pathology slides. The digital image from transportable lab 102 can be sent to a database in any location. In one or more embodiments, the transportable lab 102 contains a first imaging apparatus that utilizes WSI and a second imaging apparatus that utilizes WSI with RZS as illustrated in FIG. 2. An example of a WSI scanning device includes single scan solutions provided by Leica (e.g., Leica GT 450 scanner, etc.) and others. An example of a WSI with RZS scanning device includes solutions provided by Pramana and others.

The combination of scanners that utilize WSI and scanners that utilize WSI with RZS provides an advantage over existing configurations in that all pathology slides do not require imaging via WSI with RZS. That is, scanners that do not utilize RZS are physically smaller, require less pathology slide preparation and scan faster than scanners that utilize RZS allowing for efficient pathology slide processing in a compact transportable laboratory environment regardless of the condition of a plurality of pathology slides. Scanners utilizing WSI with RZS can z-stack slides to capture images at different depths within a tissue sample to help improve diagnostic accuracy. Scanners that utilize RZS are fault tolerant of noise (e.g., dirt, bubbles, mispositioned coverslips, cracked coverslips, pen marks, dust, fingerprints, folded tissue, weak staining, bubbles in media, etc.), physically larger than scanners that do not utilize RZS, and can carry out an effective scan for difficult to scan pathology slides with less preparation time than scanners that do not utilize RZS.

In some embodiments, the transportable lab is a detachable containerized digital pathology scanning van and is air-conditioned. The detachable containerized digital pathology scanning van provides a lab to digitize millions of pathology slides in a small space for research, education, and the development of artificial intelligence. In some embodiments, a plurality of digital pathology scanning vans can be moved to a single location to process a large number of pathology slides. As an example, six digital pathology scanning vans at a single location have the capacity to scan an estimated 8.4 million slides per year. In some embodiments, the plurality of digital pathology scanning vans outputs data to a common archive and has common links to an electronic medical record (EMR) that can associate a longitudinal medical record (e.g., patient info, diagnosis, disease stage, etc.) with a pathology slide.

FIG. 2 is a top view of an example transportable lab as taught herein. In one or more embodiments, the transportable lab 102 includes a triage stage 202, one or more first imaging apparatuses 204 that utilize WSI and one or more second imaging apparatuses 206 that utilize WSI with RZS. In one or more embodiments, the triage stage 202 includes a computing device 400 (as depicted in FIG. 3) connected to the first imaging apparatus 204 and/or second imaging apparatus 206 and executes the artificial intelligence triage model 119 (as depicted in FIG. 3).

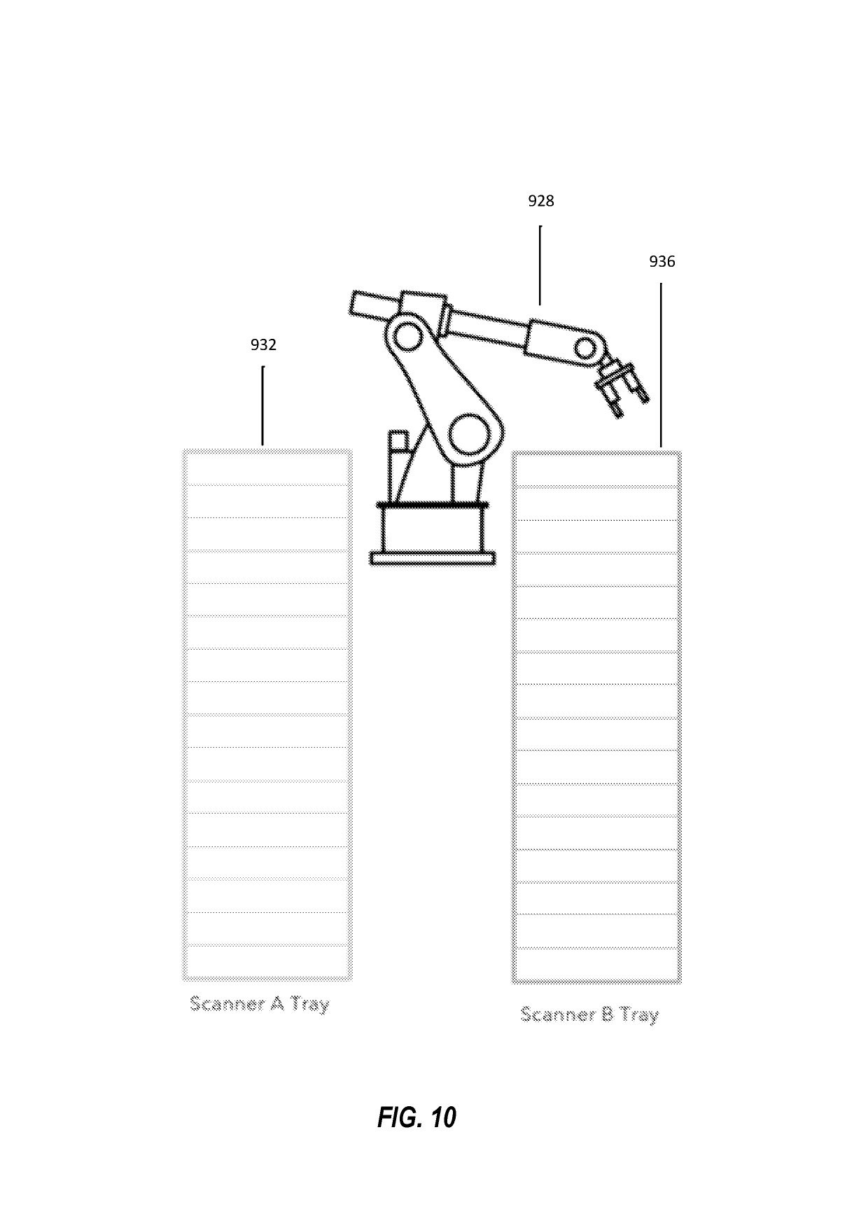

The triage stage 202 provides an environment whereby a human, computer with executable software, or computer-assisted human visually inspects pathology slides to determine the appropriate imaging apparatus and pathology slide processing steps 208 (e.g., sorting, cleaning, loading, creating unique identifiers for tracking, etc.). An example of executable software is the artificial intelligence triage model 119. Although the artificial intelligence triage model 119 is described as a single model, a person having ordinary skill in the art will appreciate that individual artificial intelligence models (e.g., robotic cleaner model, robotic system model, noise removal model, etc.) can be built for each of the described functions. Those skilled in the art will appreciate that artificial intelligence triage model 119 can operate independently of a scanning machine (e.g., WSI, WSI with RZS, etc.) or in coordination with one. In one or more embodiments, the artificial intelligence triage model 119 is based on a trained model and determines pathology slide processing steps 208 including, but not limited to, which imaging apparatus to utilize, whether or not a pathology slide needs to be cleaned, and whether to utilize an automated slide feeder. In one or more embodiments, the artificial intelligence triage model 119 is connected to one or more cameras and utilizes computer vision to help determine the appropriate pathology slide processing steps 208. In some embodiments, one or more cameras image each slide and the artificial intelligence triage model 119 evaluates the likelihood of failure for WSI versus WSI with RZS to determine the most appropriate scanner for imaging a pathology slide. In some embodiments, a plurality of cameras is utilized, wherein one camera is positioned above the pathology slide to capture images of surface reflections and identify imperfections (e.g., fingerprints, dust, dirt, etc.), while another camera images transmitted light, and yet another camera captures images of the bottom surface of the pathology slide for imperfections (e.g., fingerprints, dust, dirt, etc.). In some embodiments, the one or more cameras capture transmitted and reflected light to provide a comprehensive image of a pathology slide. In some embodiments, the one or more cameras capture images of flaws in the pathology slide based upon different angles to reveal hidden features and improve image accuracy. In some embodiments, a computer with executable software (e.g., the artificial intelligence triage model 119) may produce inconclusive recommendations about the appropriate imaging apparatus and pathology slide processing steps and a human may need to make a final decision on these issues. In some embodiments, if the artificial intelligence triage model 119 outputs an error message, the pathology slide is set aside by robotic arm 928 (as depicted in FIG. 10) and the pathology slide is later visually inspected by a human who determines the preferred scanner for imaging the pathology slide.

In some embodiments, the triage stage 202 utilizes the artificial intelligence triage model 119 to programmatically sort the pathology slides based upon pathology slide condition to determine which scanner to utilize. In some embodiments, the artificial intelligence triage model 119 can be trained on a corpus of pathology slide images that indicates which scan protocol is best to use based on the condition of the pathology slide. The triage stage 202 can include apparatuses and systems for triaging a pathology slide. In some embodiments, the triage stage 202 includes one or more pathology slide feeders. One pathology slide feeder can receive the pathology slides and feed them to an initial imaging device operationally coupled to a computational device, for example, the device illustrated in FIG. 3. The initial imaging device can capture digital images of each pathology slide and the digital image can be used to determine the processing steps 208. In some embodiments, the output of the initial imaging device is used as an input to the artificial intelligence triage model 119. In some embodiments, additional pathology slide feeders can feed pathology slides to the appropriate pathology slide imaging apparatus as described below. The pathology slide feeders can be operationally coupled to a computational device, for example, the device illustrated in FIG. 3.

In some embodiments, the triage stage 202 includes robotic cleaners. The robotic cleaners can be operationally coupled to a computational device, for example, the device illustrated in FIG. 3. The robotic cleaners can have a structure, a function and an operation to physically clean the pathology slides before they are passed to the appropriate pathology slide imaging apparatus as described below. In some embodiments, the triage stage 202 utilizes the artificial intelligence triage model 119 to programmatically determine which scanner to utilize based upon data generated by the robotic cleaners operationally coupled to a computational device. The artificial intelligence triage model 119 can be trained on a corpus of pathology slide images that indicate which scan protocol is best to use based on the condition of the pathology slides as determined by the robotic cleaners.

In some embodiments, the triage stage 202 includes robotic systems to handle and move the pathology slides. The robotic systems can be operationally coupled to a computational device, for example, the device illustrated in FIG. 3. The robotic systems can have a structure, a function and an operation to physically pick up one or more pathology slides and move a selected pathology slide to an instructed location within the transportable lab 102. In some embodiments, the triage stage 202 utilizes the artificial intelligence triage model 119 to programmatically move a pathology slide to an imaging apparatus based upon data generated by the robotic systems operationally coupled to a computational device. In some embodiments, the artificial intelligence triage model 119 is trained on a corpus of pathology slide images that indicates which scan protocol is best to use based on the condition of the pathology slides as determined by the robotic systems.

FIG. 2 also depicts an exemplary embodiment of the transportable lab 102 that includes a plurality of first imaging apparatuses 204, for example, five WSI scanners. In FIG. 2, the exemplary embodiment also includes a plurality of second imaging apparatuses 206, for example, two WSI with RZS scanners that robotically support four scan heads and are fault tolerant of dirt, bubbles, and mispositioned coverslips. In one or more embodiments, the plurality of second imaging apparatuses 206 (WSI with RZS scanners) can carry out an effective scan with less preparation time than the plurality of first imaging apparatuses 204 (scanners that do not utilize RZS). In some embodiments, the plurality of second imaging apparatuses 206 can include an array of WSI with RZS scanners that robotically support one or more scan heads and stack each pathology slide to create a series of images at different focal planes. By stacking these images, WSI with RZS scanners can produce a composite image with an enhanced depth of field that is particularly useful for complex and multi-layered tissue samples. In one or more embodiments, the overall capacity and efficiency of transportable lab 102 can be optimized by selecting the number of the first imaging apparatuses 204 and the second imaging apparatuses 206 to correspond with the quantity of pathology slides to scan.

In some embodiments, a robotic arm receives a conclusive recommendation from the artificial intelligence triage model 119 about whether to clean a pathology slide and engages in a multi-step cleaning process whereby the pathology slide is physically cleaned and/or digitally cleaned to remove noise from the images. In some embodiments, a robotic arm receives an inconclusive recommendation from the artificial intelligence triage model 119 about whether to clean a pathology slide and moves the pathology slide from a first imaging apparatus 204 or second imaging apparatus 206 to a separate area where the pathology slide can be further evaluated and/or cleaned by a human operator. In one or more embodiments, a normalization model (as depicted in FIG. 3) executed by at least one processor normalizes the output from the first imaging apparatus 204 and the output from the second imaging apparatus 206 so the output from these two imaging apparatuses is in a standardized format for analysis. The normalization model can be trained on a corpus of pathology slide images from the first imaging apparatus 204 and the second imaging apparatus 206 that indicates how to normalize the output from these two imaging apparatuses, so they are in a consistent framework for analysis. The normalization model can eliminate discrepancies and manipulate the output from the first imaging apparatus 204 and the second imaging apparatus 206 by transforming and standardizing the data so that both sources conform to a common form or scale. This allows data from the first imaging apparatus 204 and the second imaging apparatus 206 to be directly compared for further analytical processing.

FIG. 3 depicts a block diagram of an exemplary environment suitable for practicing embodiments of the present disclosure. The computing device 400 includes one or more non-transitory computer-readable media for storing one or more computer-executable instructions or software for implementing the various embodiments taught herein. The non-transitory computer-readable media may include, but are not limited to, one or more types of hardware memory (e.g., memory 456), non-transitory tangible media (for example, storage device 426, one or more magnetic storage disks, one or more optical disks, one or more flash drives, one or more solid state disks), and the like. For example, memory 456 included in the computing device 400 may store computer-readable and computer-executable instructions 460 or software (e.g., the artificial intelligence triage model 119, etc.) for implementing operations of the computing device 400. The computing device 400 also includes configurable and/or programmable processor 455 and associated core(s) 404, and optionally, one or more additional configurable and/or programmable processor(s) 402’ and associated core(s) 404’ (for example, in the case of computer systems having multiple processors/cores), for executing computer-readable and computer-executable instructions or software stored in the memory 456 and other programs for implementing embodiments of the present disclosure. Processor 455 and processor(s) 402’ may each be a single core processor or multiple core (404 and 404’) processor. Either or both of processor 455 and processor(s) 402’ may be configured to execute one or more of the instructions described in connection with computing device 400.

Virtualization may be employed in the computing device 400 so that infrastructure and resources in the computing device 400 may be shared dynamically. A virtual machine 412 may be provided to handle a process running on multiple processors so that the process appears to be using only one computing resource rather than multiple computing resources. Multiple virtual machines may also be used with one processor.

Memory 456 may include a computer system memory or random access memory, such as DRAM, SRAM, EDO RAM, and the like. Memory 456 may include other types of memory as well, or combinations thereof.

A user may interact with the computing device 400 through a visual display device 414 (e.g., a computer monitor, a projector, and/or the like including combinations and/or multiples thereof), which may display one or more graphical user interfaces 416. The user may interact with the computing device 400 using a multi-point touch interface 420 or a pointing device 418.

The computing device 400 may also include one or more computer storage devices 426, such as a hard-drive, CD-ROM, or other computer readable media, for storing data and computer-readable instructions 460 and/or software that implement exemplary embodiments of the present disclosure (e.g., applications), such as the artificial intelligence triage model 119. Although the artificial intelligence triage model 119 is described as a single model, a person having ordinary skill in the art will appreciate that individual artificial intelligence models (e.g., robotic cleaner model, robotic system model, noise removal model, etc.) can be built for each of the described functions. In one or more embodiments, the artificial intelligence triage model 119 determines which scanner to use between a first imaging apparatus that utilizes WSI and a second imaging apparatus that utilizes WSI with RZS. In one or more embodiments, the artificial intelligence triage model 119 is trained to determine which scanner to use by analyzing factors including, but not limited to, an analysis of a scan of a pathology slide, digital images, and surface reflections. In some embodiments, the artificial intelligence triage model 119 receives inputs concerning what type of tissue, slide type (e.g., anatomic pathology, cytopathology, thin-prep slides, etc.) or stain type (e.g., IHC immuno histo-chemistry, H&E (Hematoxylin and Eosin), etc.) was utilized in a pathology slide when determining which scanner to use. In one or more embodiments, the artificial intelligence triage model 119 is trained on a plurality of good and bad pathology slides and programmatically determines whether a pathology slide is passed to a WSI or WSI with RZS scanner. In some embodiments, the artificial intelligence triage model 119 is a self-training model that progressively improves as it incorporates more data into its training.

In one or more embodiments, the artificial intelligence triage model 119 programmatically determines which scanner to utilize based upon data generated by robotic cleaners operationally coupled to a computational device. In one or more embodiments, the artificial intelligence triage model 119 can be trained on a corpus of pathology slide images that indicates which scan protocol is best to use based on the condition of the pathology slides as determined by robotic cleaners. In one or more embodiments, the artificial intelligence triage model 119 is trained on a plurality of good and bad pathology slides as determined by robotic cleaners and programmatically determines whether a pathology slide is passed to a WSI or WSI with RZS scanner.

In one or more embodiments, the artificial intelligence triage model 119 programmatically moves a pathology slide to an imaging apparatus based upon data generated by robotic systems operationally coupled to a computational device. In one or more embodiments, the artificial intelligence triage model 119 can be trained on a corpus of pathology slide images that indicates which scan protocol is best to use based on the condition of the pathology slides as determined by robotic systems. In one or more embodiments, the artificial intelligence triage model 119 is trained on a plurality of good and bad pathology slides as determined by robotic systems and programmatically determines whether a pathology slide is passed to a WSI or WSI with RZS scanner.

In one or more embodiments, the artificial intelligence triage model 119 programmatically determines what is tissue versus non-tissue in a pathology slide and removes non-tissue noise to provide an improved image of a difficult to scan pathology slide. In one or more embodiments, the artificial intelligence triage model 119 can be trained on a corpus of pathology slide images that indicates what is tissue versus non-tissue in a pathology slide. In one or more embodiments, the artificial intelligence triage model 119 is trained to distinguish between tissue and non-tissue and programmatically generates an improved image of a difficult to scan pathology slide by removing non-tissue noise.

In some embodiments, the normalization model 480 is a trained artificial intelligence model built to normalize the output of the WSI scanning device and the RZS scanning device so the output from these two imaging apparatuses is in a standardized format. The normalization model 480 can eliminate discrepancies and manipulate the output from the first imaging apparatus 204 and the second imaging apparatus 206 by transforming and standardizing the data so that both sources conform to a common form or scale. This allows data from the first imaging apparatus 204 and the second imaging apparatus 206 to be directly compared for further analytical processing.

The computing device 400 can include a communications interface 454 configured to interface via one or more network devices 424 with one or more networks, for example, Local Area Network (LAN), Wide Area Network (WAN) or the Internet through a variety of connections including, but not limited to, standard telephone lines, LAN or WAN links (for example, 802.11, T1, T3, 56kb, X.25), broadband connections (for example, ISDN, Frame Relay, ATM), wireless connections, controller area network (CAN), or some combination of any or all of the above. In exemplary embodiments, the computing device 400 can include one or more antennas 422 to facilitate wireless communication (e.g., via the network interface) between the computing device 400 and a network and/or between the computing device 400 and components of the system, between the computing device 400 and another computing device (not shown), between the computing device 400 and a cloud 464 computing device, and/or the like including combinations and/or multiples thereof. The communications interface 454 may include a built-in network adapter, network interface card, PCMCIA network card, card bus network adapter, wireless network adapter, USB network adapter, modem or any other device suitable for interfacing the computing device 400 to any type of network capable of communication and performing the operations described herein.

The computing device 400 may run an operating system 410, such as versions of the Microsoft® Windows® operating systems, different releases of the Unix® and Linux® operating systems, versions of the MacOS® for Macintosh computers, embedded operating systems, real-time operating systems, open source operating systems, proprietary operating systems, or other operating systems capable of running on the computing device 400 and performing the operations described herein. In exemplary embodiments, the operating system 410 may be run in native mode or emulated mode. In an exemplary embodiment, the operating system 410 may be run on one or more cloud 464 machine instances.

The computing device 400 can host one or more applications (e.g., instructions 460 or software, and any/or mechanical, motive, or electronic systems associated with these system aspects; or graphical user interfaces 416) to facilitate access to the content of the databases 152. The databases 152 may store information or data including instructions 460 or software, or imaging data as described above. Information from the databases 152 can be retrieved by the computing device 400 through a communications network during an imaging or scanning operation. The databases 152 can be located in the cloud 464 or at one or more geographically distributed locations away from some or all system components and/or the computing device 400. Alternatively, the databases 152 can be located at the same geographical location as the computing device 400 and/or at the same geographical location as the system components. The computing device 400 can be geographically distant from other system components. The computing device 400 can also be located entirely off-site in a remote facility.

In an example embodiment, one or more portions of the communications interface 454 can be an ad hoc network, a mesh network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a Wi-Fi network, a WiMAX network, an Internet-of-Things (IoT) network established using BlueTooth® or any other protocol, any other type of network, or a combination of two or more such networks.

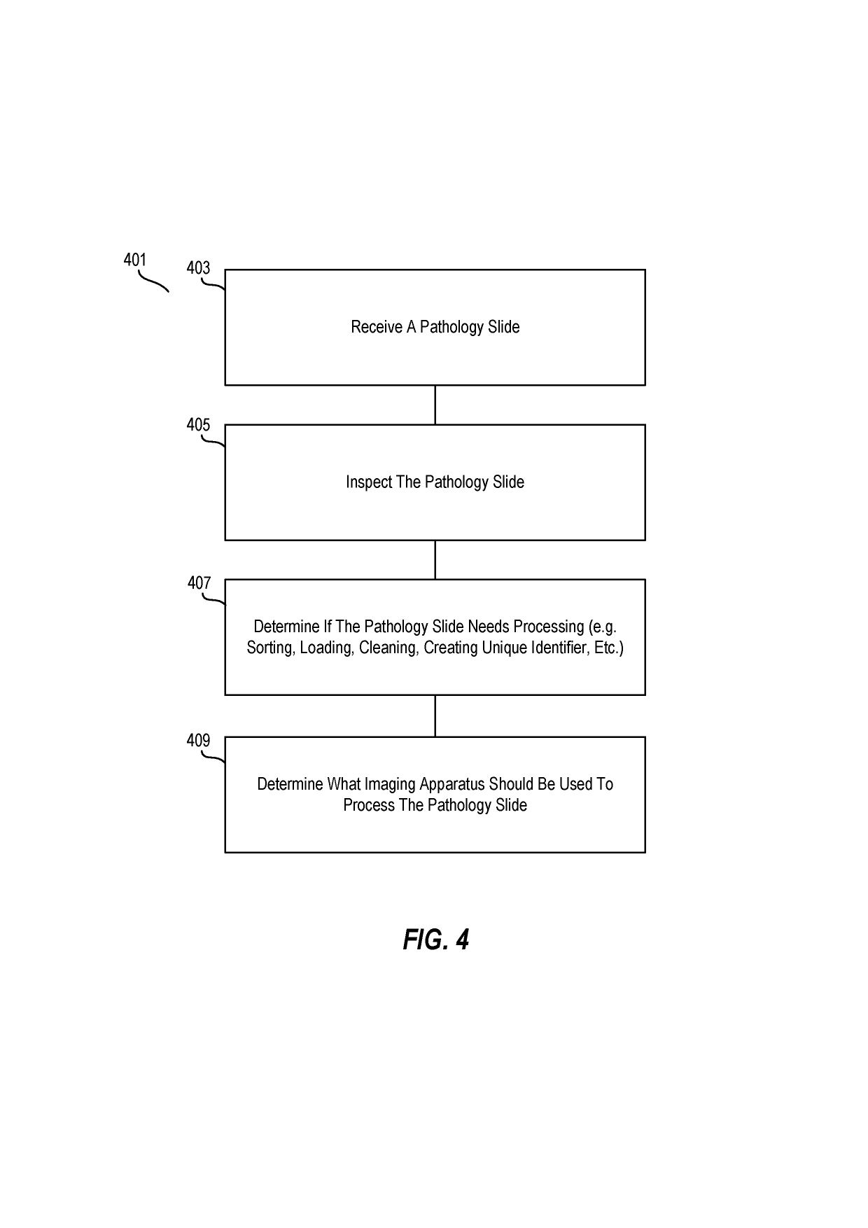

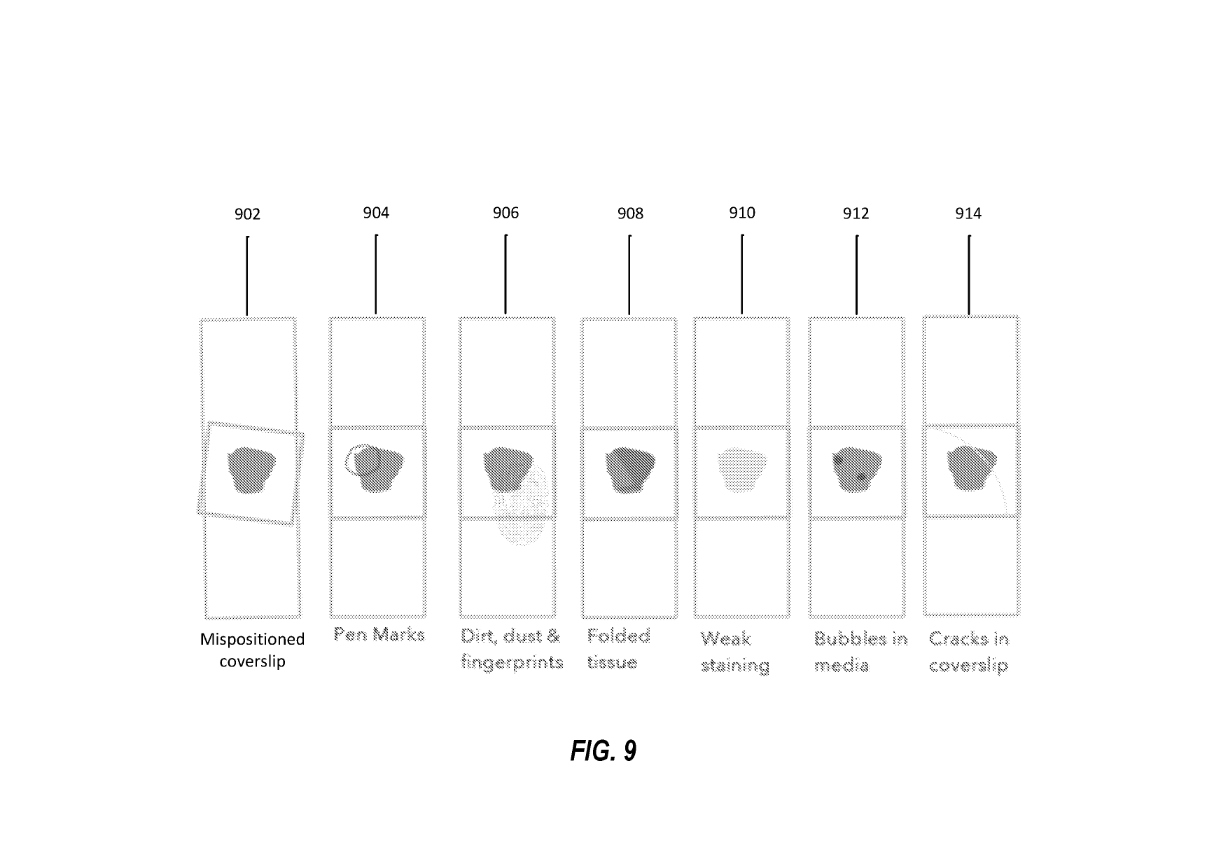

FIG. 4 depicts an example flow diagram of a method 401 taught herein for a triage model 202 to determine processing steps 208. At block 403, the method 401 includes receiving a pathology slide. At block 405, the method 401 includes inspecting the pathology slide for imperfections (as depicted in FIG. 9). In some embodiments, the pathology slide is digitally inspected with a triage model 202. At block 407, the method 401 includes determining if the pathology slide needs any processing (e.g. sorting, loading, cleaning, creating unique identifiers for tracking, etc.). In some embodiments, determining if the pathology slide needs any processing is based upon the output of triage model 202. In some embodiments, a human operator can determine processing steps 208 instead of triage model 202. At block 409, the method 401 includes determining which imaging apparatus to utilize for processing the pathology slide between a first imaging apparatus 204 that utilizes WSI and a second imaging apparatus 206 that utilizes WSI with RZS. In some embodiments, determining which imaging apparatus to utilize for processing the pathology slide is based upon the output of triage model 202.

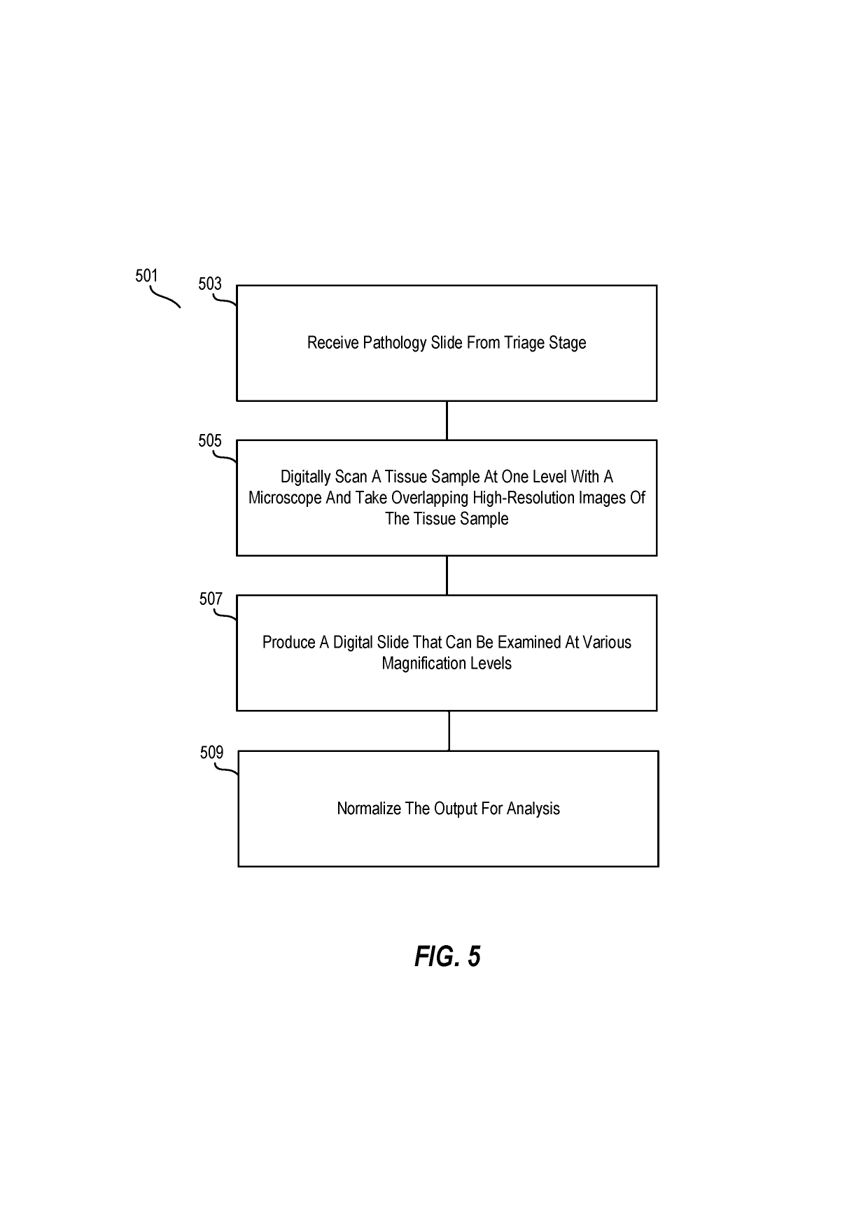

FIG. 5 depicts an example flow diagram of a method 501 taught herein for utilizing WSI. In WSI, a digital scanning microscope is focused on the tissue of a pathology slide at one level, and a digital pathology slide is produced. This requires the pathology slide to be clean, shaped without coverslip misplacement or bubbles in the coverslip cement. This method is fast and uses machines suitable for small spaces. At block 503, the method 501 includes receiving a pathology slide from the triage stage 202. At block 505, the method 501 includes digitally scanning a tissue sample at one level with a microscope and taking overlapping high-resolution images of the tissue sample. At block 507, the method 501 includes producing a digital pathology slide that can be examined at various magnification levels. In one or more embodiments, WSI executes the artificial intelligence triage model 119 to programmatically select and/or orchestrate imaging of the pathology slide. In some embodiments, a normalization process can be carried out by a normalization model 480. At block 509, the method 501 includes the use of the normalization model 480 to normalize the output from the first imaging apparatus 204 and the second imaging apparatus 206 so the output from these two imaging apparatuses are in a standardized format for analysis. This allows data from the first imaging apparatus 204 and the second imaging apparatus 206 to be directly compared for further analytical processing.

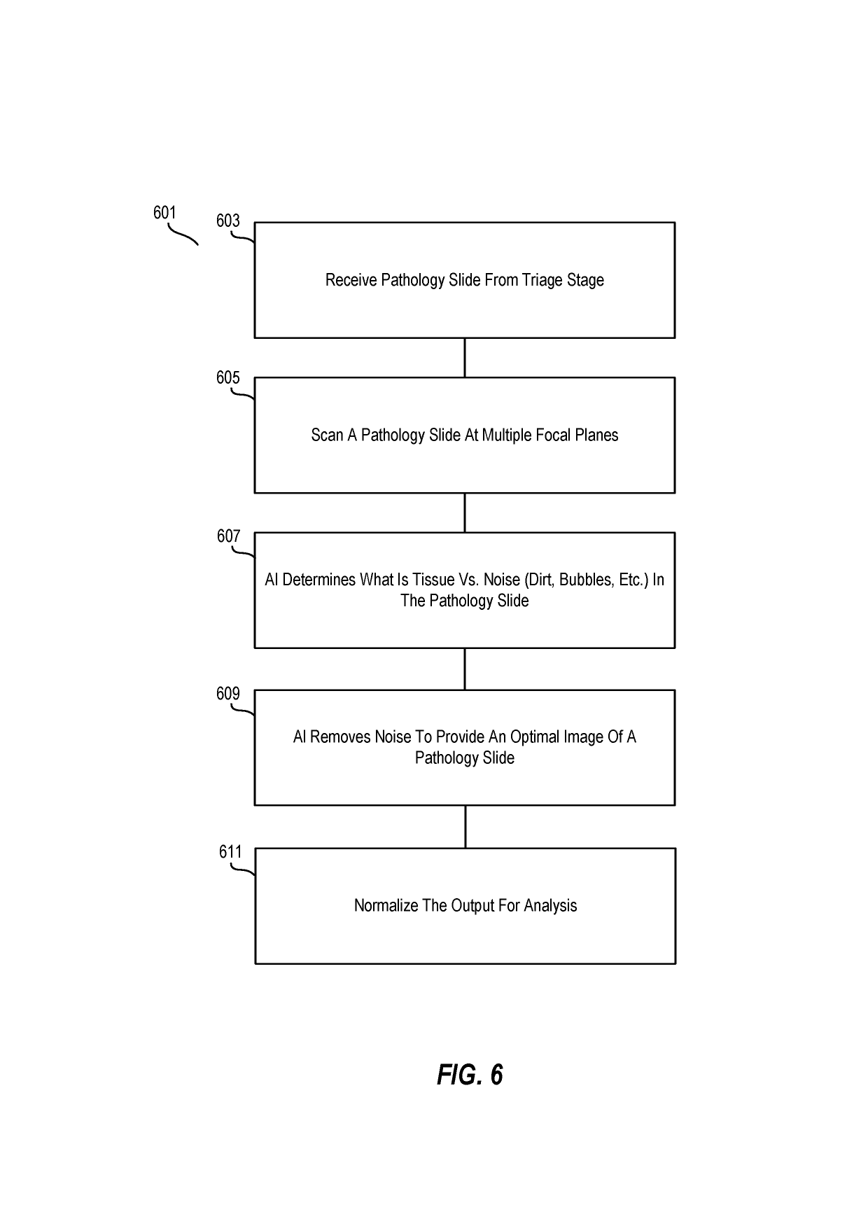

FIG. 6 depicts an example flow diagram of a method 601 taught herein for utilizing WSI with RZS. At block 603, the method 601 includes receiving a pathology slide from the triage stage 202. At block 605, the method 601 includes scanning a pathology slide at multiple focal planes. At block 607, the method 601 includes use of the artificial intelligence triage model 119 to distinguish between what is tissue versus noise in the pathology slide. At block 609, the method 601 includes use of the artificial intelligence triage model 119 to remove the noise (e.g., dirt, bubbles, etc.) and provide an improved image of the pathology slide. At block 611, the method 601 includes the use of normalization model 480 to normalize the output from the first imaging apparatus 204 and the second imaging apparatus 206 so the output from these two imaging apparatuses are in a standardized format for analysis. This allows data from the first imaging apparatus 204 and the second imaging apparatus 206 to be directly compared for further analytical processing.

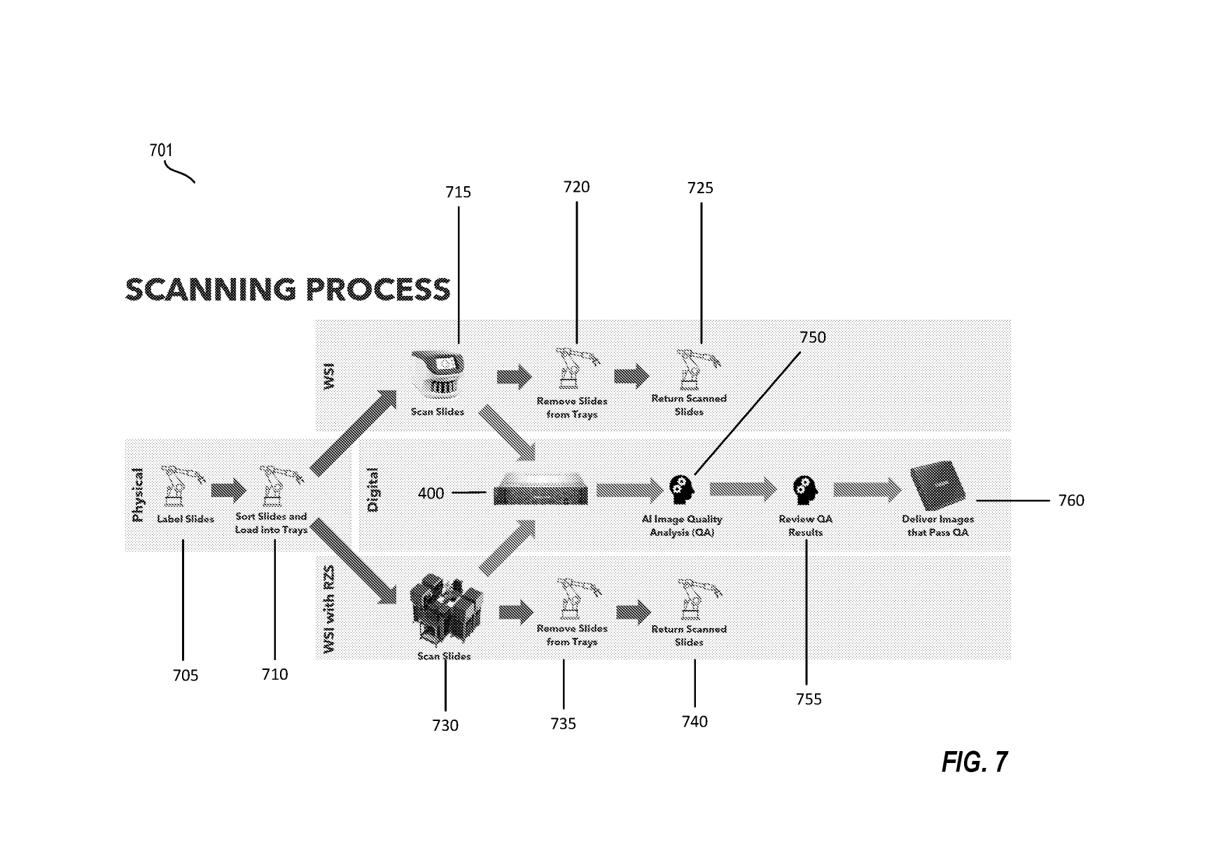

FIG. 7 depicts an example flow diagram of a scanning process 701 including a WSI scanning device 204 and a WSI with RZS scanning device 206. At step 705, the scanning process 701 includes the robotic arm 928 (as depicted in FIG. 10) labeling pathology slides by adding barcode stickers to the pathology slides. In some embodiments, the pathology slides with barcode stickers reference a database which connects an image of the pathology slide to a patient’s other clinical information (e.g., diagnosis, age, gender, disease stage, treatment, etc.). At step 710, robotic arm 928 sorts the pathology slides based upon directions from the artificial intelligence triage model 119, and then loads the pathology slides into trays designated for WSI or trays designated for WSI with RZS. In one or more embodiments, the artificial intelligence triage model 119 is trained to sort the pathology slides by learning which features or patterns correspond to WSI or WSI with RZS. In some embodiments, the artificial intelligence triage model 119 outputs a single binary decision (e.g., WSI or WSI with RZS) when sorting the pathology slides without distinguishing between different types of pathology slide imperfections (e.g., dirt, bubbles, etc.). In some embodiments, when sorting the pathology slides, the artificial intelligence triage model 119 identifies and distinguishes between different pathology slide imperfections (e.g., dirt, bubbles, etc.) so that each type of detected defect is labeled separately rather than collapsed into a binary decision (e.g., WSI or WSI with RZS). At step 715, robotic arm 928 feeds pathology slides designated for WSI to a WSI scanning device 204. After the pathology slides are scanned by the WSI scanning device 204, the robotic arm 928 removes the pathology slides from trays at step 720 and the scanned pathology slides are returned to pathology slide file boxes at step 725. At step 730, the robotic arm 928 feeds pathology slides designated for WSI with RZS to a WSI with RZS scanning device 206. After the pathology slides are scanned by the WSI with RZS scanning device 206, the robotic arm 928 removes the pathology slides from trays at step 735 and the scanned pathology slides are returned to pathology slide file boxes at step 740. Furthermore, after the pathology slides designated for WSI are scanned at step 715 by a WSI scanning device 204 and the pathology slides designated for WSI with RZS are scanned at step 730 by a WSI with RZS scanning device 206, digital images of the scanned pathology slides are sent to a computing device 400. The scanning process 701 at step 750 includes image quality analysis to automatically evaluate the quality of the digital images. At step 755, a review of the quality analysis results is conducted by one or more quality control algorithms to verify imperfections (e.g., dirt, tissue folds, bubbles, ink, out of focus, etc.) that may interfere with subsequent use of the pathology slide. At step 760, the digital images that pass quality analysis are stored in computing device 400 for further use.

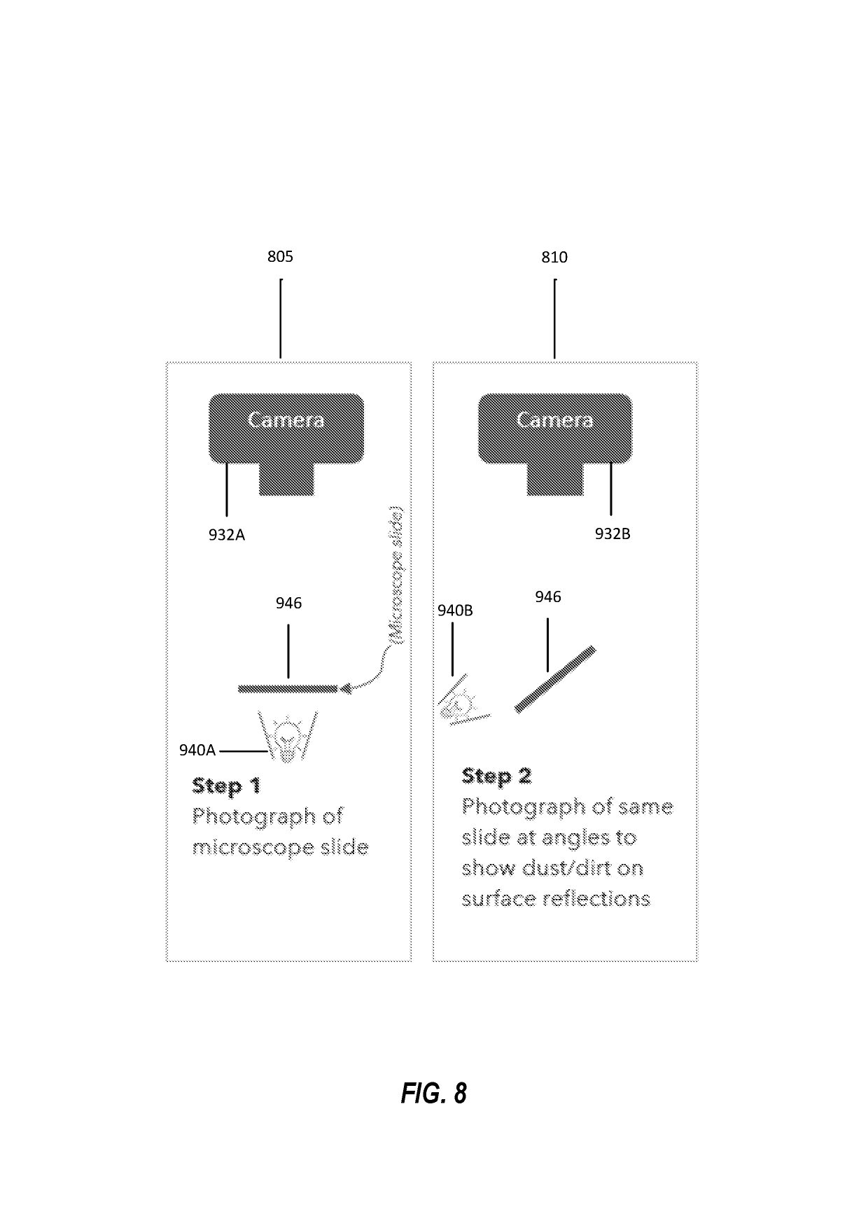

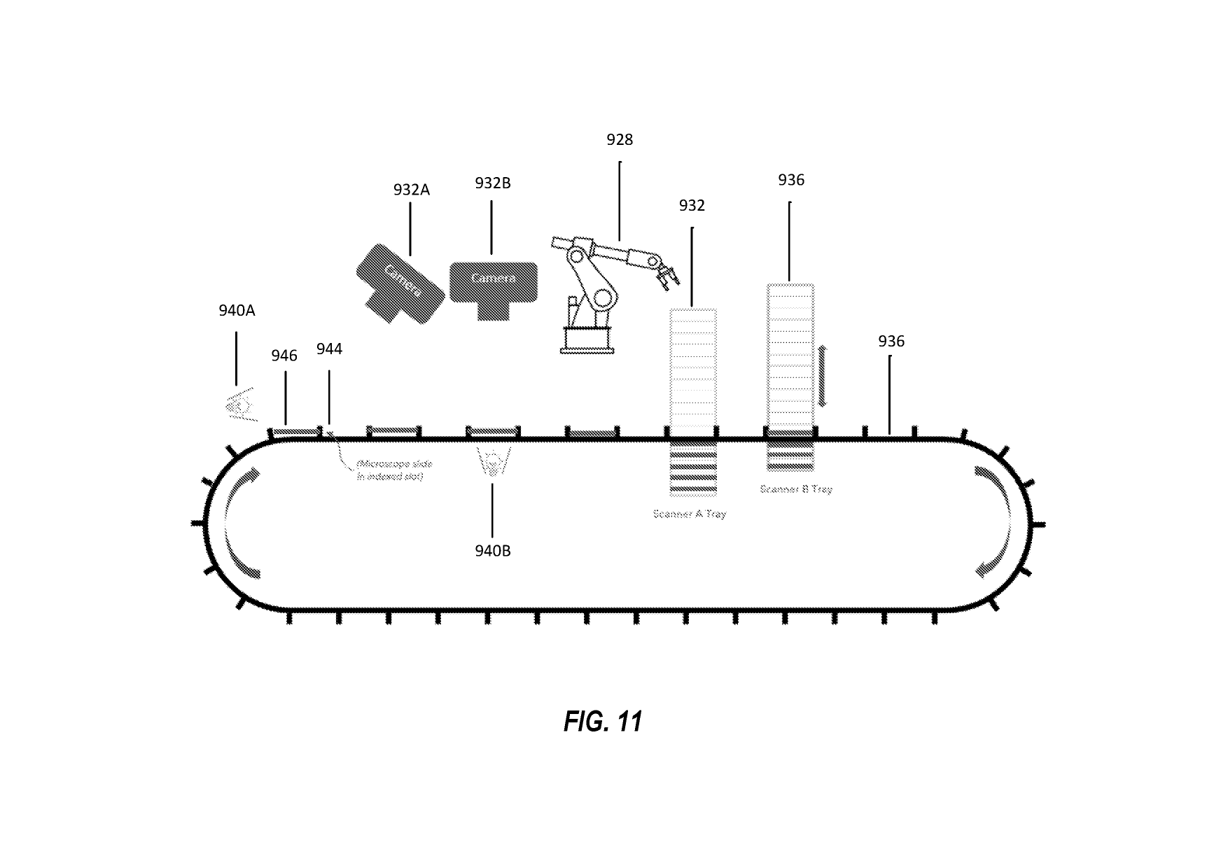

FIG. 8 depicts an example process of imaging a pathology slide 946 from different angles, which is also depicted in FIG. 11 described below. FIG. 8 includes one or more light sources, for example, a first light source 940A and a second light source 940B. In one or more embodiments, the process for imaging the pathology slide 946 involves one or more imaging steps. In some embodiments, first step 805 involves taking a primary image with a first camera 932A that best captures the overall appearance of the pathology slide 946. In some embodiments, the first step 805 includes illuminating the pathology slide 946 from two different angles to capture light transmitted there through and light reflected therefrom. In some embodiments, the first light source 940A is below or above the pathology slide 946. In some embodiments, second step 810 involves capturing additional images of the pathology slide 946 from one or more horizontal angles with a second camera 932B relative to the position of the first camera 932A to indicate imperfections (e.g., dust or dirt) based on irregular surface reflections. In one or more embodiments, this process for imaging pathology slide 946 from multiple angles provides a more complete and accurate representation of the condition of the pathology slide 946. Those skilled in the art will appreciate that the positioning of the first light source 940A and the second light source 940B relative to the first camera 932A and the second camera 932B may be different from what is depicted in FIG. 8. Those skilled in the art will appreciate that various combinations of multiple light sources and multiple cameras can be employed.

FIG. 9 depicts example pathology slides with flaws. More specifically, potential flaws include (i) mispositioned coverslip 902 (ii) pen marks 904 (iii) dirt, dust and fingerprints 906 (iv) folded tissue 908 (v) weak staining 910 (vi) bubbles in media 912 and (vii) cracks in coverslip 914. In some embodiments, an artificial intelligence model is trained on images of pathology slides to detect issues such as (i) mispositioned coverslip (ii) pen marks (iii) dirt, dust and fingerprints (iv) folded tissue (v) weak staining (vi) bubbles in media and (vii) cracks in coverslip.

FIG. 10 depicts an example robotic arm placing pathology slides in different trays. In one or more embodiments, the robotic arm 928 places a pathology slide in either scanner A tray 932 (e.g. for subsequent scanning by a WSI scanning device) or in scanner B tray 936 (e.g. for subsequent scanning by a WSI with RZS scanning device). In one or more embodiments, the robotic arm 928 utilizes output from the artificial intelligence triage model 119 to (i) presort pathology slides to scan with WSI or WSI with RZS (ii) select pathology slides not to be scanned or (iii) move pathology slides to a subsequent processing step 208. In one or more embodiments, the artificial intelligence triage model 119 determines which scanner type (e.g., WSI, WSI with RZS, etc.) to use and instructs the robotic arm 928 to pick up a pathology slide and place the pathology slide before one or more cameras (e.g., first camera 932A, first camera 932B, etc.). In one or more embodiments, the artificial intelligence triage model 119 recognizes that a specific slot was utilized and in the next event utilizes a tray increment to position the robotic arm 928 at the next open slot. In one or more embodiments, if all the slots are filled, the robotic arm 928 replaces the full tray with an empty tray.

FIG. 11 depicts an example conveyor belt system for scanning pathology slides in a transportable lab. In some embodiments, one or more cameras, for example, the first camera 932A and the second camera 932B can be positioned relative to a conveyer belt 936 to capture reflected or emitted light and transmitted or blocked light, for example, extinction, respectively. The system depicted in FIG. 11 includes one or more light sources, for example, the first light source 940A and the second light source 940B are positioned relative to the conveyer belt 936 to illuminate pathology slides as they pass along the conveyer belt 936 in order for the first camera 932A and the second camera 932B to collect light as described above. In some embodiments, the first light source 940A is positioned above the conveyer belt 936 and positioned downward toward the conveyor belt 936 or horizontally relative to conveyer belt 936. In some embodiments, the second light source 940B is positioned below the conveyer belt 936 and positioned upward toward the conveyor belt 936 or vertically relative to conveyer belt 936. Those skilled in the art will appreciate that the positioning of the first light source 940A and the second light source 940B relative to the first camera 932A and the second camera 932B may be different from what is depicted in FIG. 11. In one or more embodiments, the pathology slide 946 can be picked up by the robotic arm 928 and inserted into a slide tray (e.g., scanner A tray 932, scanner B tray 936, etc.). In one or more embodiments, the trays can be indexed with indexed slots 944 and servo driven to the next open slot on a slide tray. In one or more embodiments, computing device 400 keeps track of which indexed slots 944 has which pathology slides, and then once a pathology slide is imaged, the artificial intelligence triage model 119 decides which tray to move that pathology slide to. In one or more embodiments, the pathology slides are moved from the conveyor belt 936 into a tray designated for WSI or a tray designated for WSI with RZS by an actuator(s) (not shown) using output from the cameras 932A and 932B. In one or more embodiments, the cameras 932A and 932B image a pathology slide, and if imperfections (as depicted in FIG. 9) are detected by the artificial intelligence triage model 119, then the artificial intelligence triage model 119 directs the pathology slide to a tray for the appropriate scanner type (e.g., WSI, WSI with RZS, etc.). In one or more embodiments, if the pathology slide 946 is pushed from the conveyor belt 936 to a pathology slide tray (e.g., scanner A tray 932, scanner B tray 936, etc.), the need for the robotic arm 928 to move the pathology slide 946 at this step is eliminated. In one or more embodiments, the conveyor belt 936 may be used with or without indexing 944 to move the pathology slides from task to task. When operating with indexed slots 944, the conveyor belt 936 operates in a stepwise manner and stops at precise intervals so the pathology slides are positioned accurately within a slide tray. In one or more embodiments, sensors or a timer or both can be used to automatically stop or start the conveyer belt 936 for imaging, lateral movement of the pathology slides, or to transfer the pathology slides to the robotic arm 928. The sensors and the timer can assist to ensure that the pathology slides are moved when certain conditions are fulfilled (e.g., a pathology slide is correctly positioned according to one or more cameras).

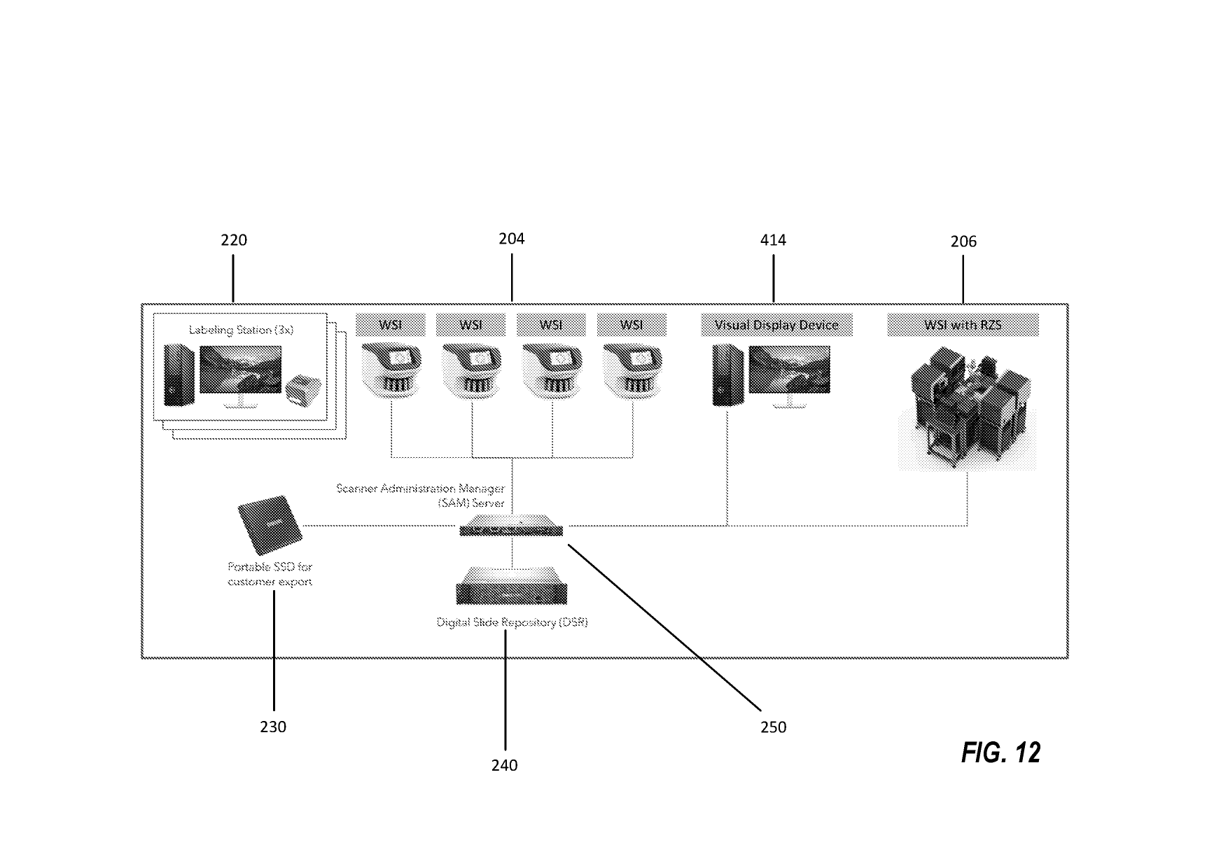

FIG. 12 depicts an example hardware architecture for hybrid modular pathology archive scanning. Labeling station 220 is utilized to apply barcodes to pathology slides and enable tracking of the pathology slides. The labeled pathology slides are then fed to one or more slide scanners (e.g., WSI 204, WSI with RZS 206, etc.) which capture digital images of the pathology slides. Visual display device 414 allows users to preview, control, or verify scan quality of the pathology slides in real time. The resulting pathology slide image data can be transferred to portable SSD 230 for secure storage or transport. The pathology slide images are also transmitted to a centralized scanner administration manager (SAM) server 250 which manages data processing of the pathology slide images. Additionally, the processed digital pathology slides are archived in a digital slide repository 240 that supports retrieval and sharing of the digital pathology slides.

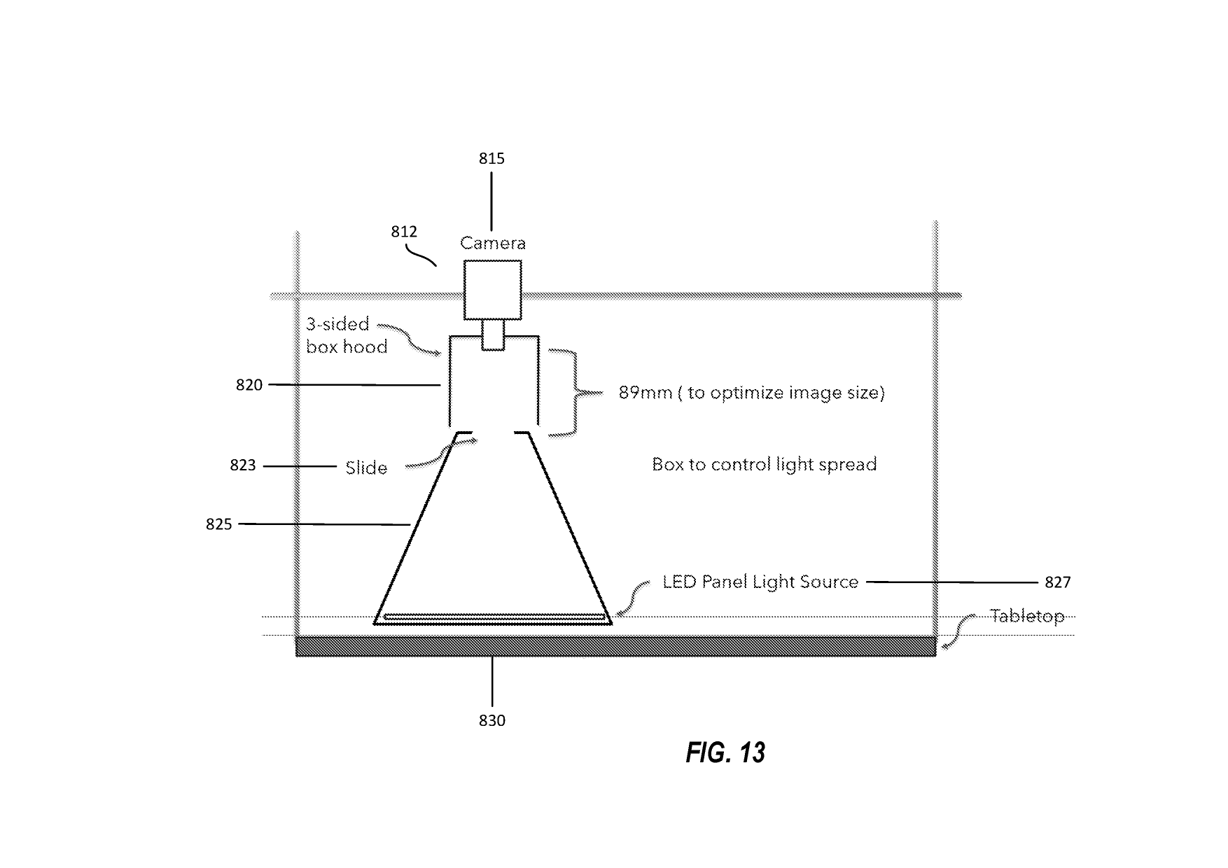

FIG. 13 depicts an example side view trapezoidal prism design of an optical setup for imaging pathology slides. In FIG. 13, a tower 812 is situated on a tabletop 830 and enables a diffuse light source a significant distance from pathology slide 823 to be imaged so properties of the light source or pathology slide imperfections (e.g., dust on the light source) are out of focus and not imaged. In some embodiments, the artificial intelligence triage model 119 utilizes the tower 812 to filter and sort slides. In FIG. 13, the tower 812 includes a camera 815 that is affixed to a 3-sided box hood 820, which are positioned above the pathology slide 823. The 3-sided box hood 820 serves as a shade to reduce unwanted surface reflections (e.g., overhead lights) and surrounds the camera 815’s field of view to help block out light and reflections and create a controlled imaging environment for the pathology slide 823. Those skilled in the art will appreciate that the size of the 3-sided box hood 820 can be adjusted for desired image quality results. Within the tower 812, the pathology slide 823 is suspended in a bezel above box to control light spread 825. To maintain consistent lighting conditions, the box to control light spread 825 is utilized to prevent over or under illumination. LED panel light source 827 is situated at the bottom of box to control light spread 825. The LED panel light source 827 provides illumination of the pathology slide 823 for imaging and can be adjusted to ensure even brightness for the pathology slide 823. In some embodiments, the pathology slide 823 is suspended in a bezel and does not lay on a clear material such as glass since any dust or surface reflection on the glass could appear in the pathology slide images.

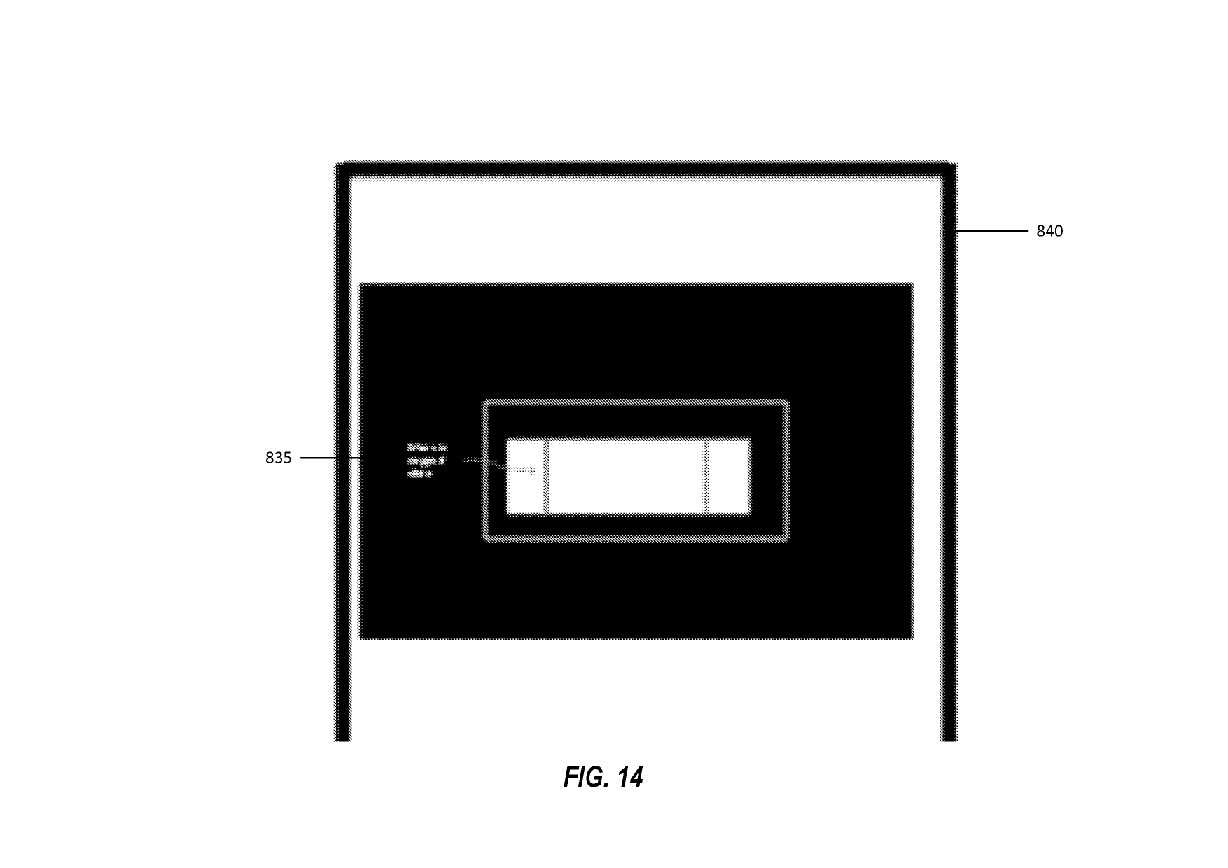

FIG. 14 depicts an example box hood top view of a camera top view. In FIG. 14, wires 835 are extended around the pathology slide 823 to provide structural support. The wires 835 are positioned around the pathology slide 823 to stabilize the pathology slide 823 and maintain its alignment during imaging. In some embodiments, the wires 835 support the pathology slide 823 using two consistent metal wires. Although the wires 835 can introduce an artifact into pathology slide images, the wires 835 help suspend the pathology slide 823 and enable clear imaging of pathology slide edges which is important to capture coverslips, labels, tape, or anything else that may inhibit imaging.

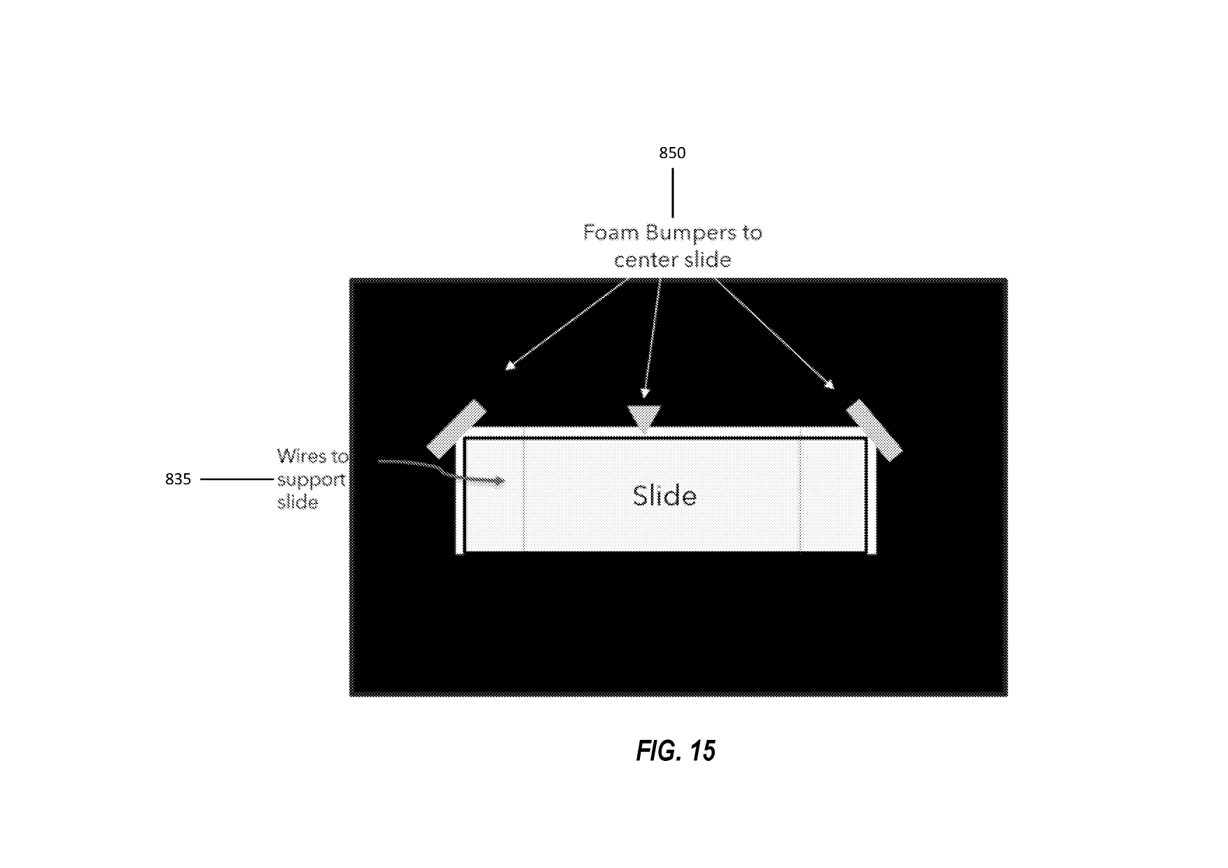

FIG. 15 depicts an example slide tray close up. In FIG. 15, the wires 835 are extended around the pathology slide 823 to provide structural support. The wires 835 are positioned around the pathology slide 823 to stabilize the pathology slide 823 and maintain its alignment during imaging. In FIG. 15, foam bumpers 850 are also positioned along the pathology slide 823 to help center and secure the pathology slide 823 in place during imaging. In one or more embodiments, the foam bumpers 850 hold the pathology slide 823 by the corners and eliminate the need for using the wires 835 that cross the tissue area of the pathology slide 823 and can appear as an artifact in pathology slide images. In some embodiments, with a robotic approach, a slide bezel may serve as a window and the pathology slide 823 is held by a robot when imaging the pathology slide 823.

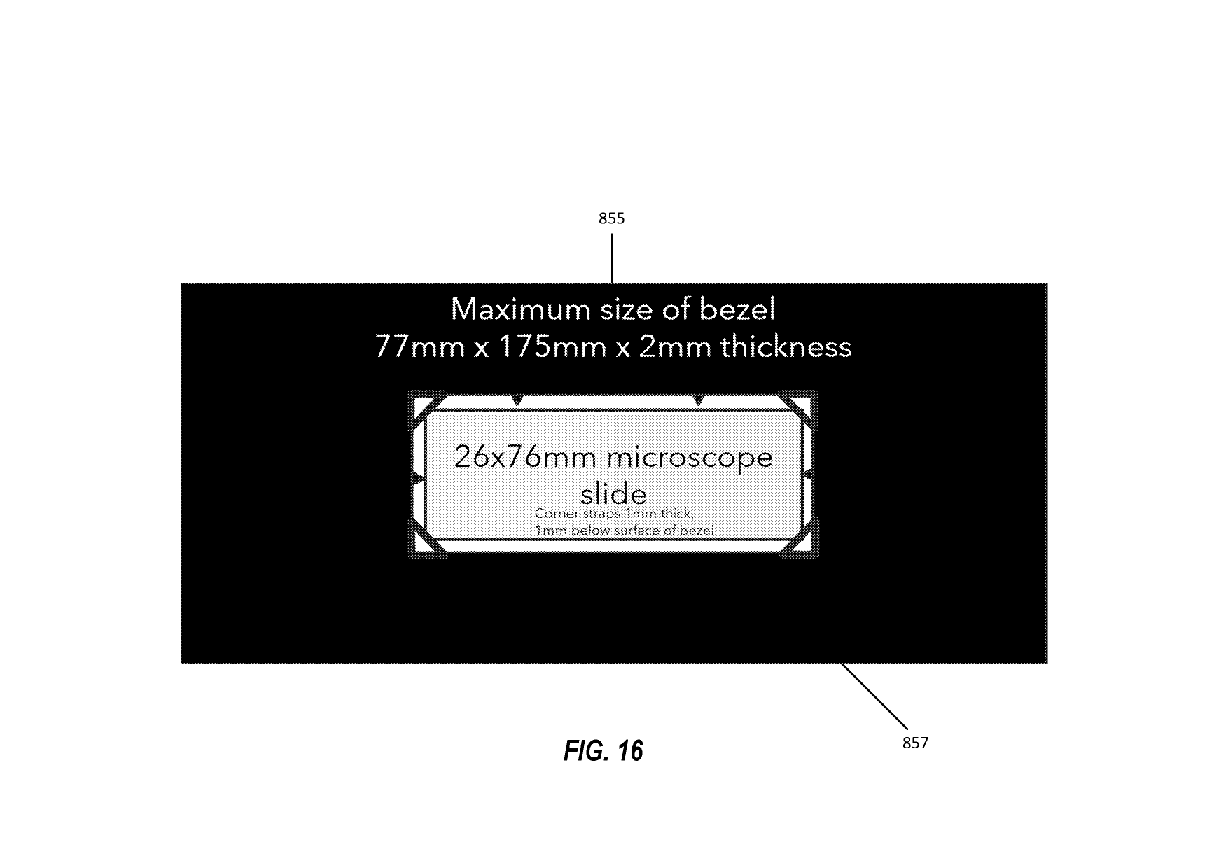

FIG. 16 depicts an example illustration of alternate bezel and pathology slide fit. In FIG. 16, maximum bezel size 855 for the pathology slide 823 is 77mm x 175mm x 2mm. 26 x 76mm microscope slide 857 is positioned within the maximum bezel size 855 to demonstrate its relative size. Furthermore, the 26 x 76mm microscope slide 857 includes corner straps 1mm thick and 1mm below surface of the bezel.

FIGS. 17A and 17B depict an example model training report for efficientnet. Model training report 860 includes project information 862 such as dataset, model type, training started, training completed, testing started, and testing completed. Test results 864 include metrics such as accuracy, sensitivity (recall), specificity, PPV (precision), NPV, prevalence, F1 score, and Matthews correlation coefficient. ROC curve analysis 866 illustrates the tradeoffs between true positive and false positive rates. Confusion matrix 868 shows how often each class was correctly or incorrectly predicted by efficientnet. Per-class performance 870 lists each class alongside its precision, recall, F1 score, and support.

FIGS. 18A and 18B depict an example model training report for RESNET50. Model training report 880 includes project information 882 such as dataset, model type, training started, training completed, testing started, and testing completed. Test results 884 include metrics such as accuracy, sensitivity (recall), specificity, PPV (precision), NPV, prevalence, F1 score, and Matthews correlation coefficient. ROC curve analysis 886 illustrates the tradeoffs between true positive and false positive rates. Confusion matrix 888 shows how often each class was correctly or incorrectly predicted by RESNET50. Per-class performance 890 lists each class alongside its precision, recall, F1 score, and support.

Since certain changes may be made without departing from the scope of the present invention, it is intended that all matter contained in the above description or shown in the accompanying drawings be interpreted as illustrative and not in a literal sense. Practitioners of the art will realize that the sequence of steps and architectures depicted in the figures may be altered without departing from the scope of the present invention and that the illustrations contained herein are singular examples of a multitude of possible depictions of the present invention.

The foregoing description of example embodiments of the invention provides illustration and description, but is not intended to be exhaustive or to limit the invention to the precise form disclosed. Modifications and variations are possible in light of the above teachings or may be acquired from practice of the invention. For example, while a series of acts has been described, the order of the acts may be modified in other implementations consistent with the principles of the invention. Further, non-dependent acts may be performed in parallel. Likewise, modules described as separate may be combined into a single module or separated into additional modules without departing from the scope of the present invention.

What is claimed is:

1. A computing device-implemented method to optimize digital scanning of pathology slides in a transportable lab, the method comprising:
receiving a plurality of pathology slides in the transportable lab;
sorting the plurality of pathology slides based upon pathology slide condition to determine which of a plurality of scanners to utilize; and
scanning at least one of the plurality of pathology slides utilizing Whole Slide Imaging (WSI) or WSI with Robotic Z-Stacking (RZS) to generate a digital pathology slide.

2. The method of claim 1, wherein the WSI includes a digital scanning microscope focused on a tissue at one level.

3. The method of claim 1, wherein the WSI with RZS includes a robotic arm to feed one or more of the plurality of pathology slides to multiple scanners that individually scan the one or more of the plurality of pathology slides at multiple focal planes.

4. The method of claim 1, wherein the transportable lab is located in a van.

5. The method of claim 1, wherein the transportable lab can be relocated to a different pathology slide archive.

6. The method of claim 1, wherein the sorting of the plurality of pathology slides is automated by an artificial intelligence triage model.

7. The method of claim 1, wherein the sorting of the plurality of pathology slides determines whether the plurality of pathology slides are allocated to the WSI or the WSI with RZS.

8. The method of claim 1, wherein a pathology slide scanned utilizing the WSI is clean and satisfies criteria for WSI scanning.

9. The method of claim 1, wherein the WSI with RZS is tolerant of inconsistent pathology slide shapes and off sizes or overhanging coverslips.

10. The method of claim 1, wherein preselecting through hybrid optimization which of the plurality of pathology slides to clean and which of the plurality of pathology slides not to clean is determined by executing an artificial intelligence triage model.

11. The method of claim 10, wherein sorting the plurality of pathology slides based upon pathology slide condition can be automated by the artificial intelligence triage model.

12. The method of claim 1, wherein one or more transportable labs can be utilized to optimize a workflow of the digital scanning of the plurality of pathology slides.

13. The method of claim 1, wherein a noise removal model executed by at least one processor determines what is tissue versus non-tissue in at least one of the pathology slides and removes non-tissue noise to provide an improved image.

14. The method of claim 1, wherein the scanning of the plurality of pathology slides converts analog slides to digital images.

15. A transportable system for scanning pathology slides, the system comprising:
a triage stage for analyzing each of the pathology slides for digital scanning;
a plurality of first slide imaging apparatuses for Whole Slide Imaging (WSI); and
a plurality of second slide imaging apparatuses for WSI with Robotic Z-Stacking (RZS).

16. The transportable system of claim 15, wherein a noise removal model executed by at least one processor determines what is tissue versus non-tissue in at least one of the pathology slides and removes non-tissue noise to provide an improved image.

17. The transportable system of claim 15, wherein the WSI includes a digital scanning microscope focused on a tissue at one level.

18. The transportable system of claim 15, wherein the WSI with RZS includes a robotic arm to feed one or more of the pathology slides to multiple scanners that individually scan the one or more of the pathology slides at multiple focal planes.

19. The transportable system of claim 15, wherein one or more transportable labs can be utilized to optimize a workflow of the digital scanning of the pathology slides.

20. The transportable system of claim 15, wherein the triage stage includes one or more robotic systems to feed and/or clean the pathology slides.

21. The transportable system of claim 20, wherein a processor executes one or more artificial intelligence models to instruct or control the one or more robotic systems.
